(19) United States
(12) Patent Application Publication
(10) Pub. No.: US 2002/0188713 A1
(43) Pub. Date: Dec. 12, 2002

(54) Distributed architecture for a telecommunications system

(76) Inventors: Jack Bloch, Boca Raton, FL (US); Le Van Dinh, Boca Raton, FL (US); Amruth Laxman, Boca Raton, FL (US); Van P. T. Phung, Coral Springs, FL (US)

Correspondence Address: Siemens Corporation, Intellectual Property Department, 186 Wood Avenue South, Iselin, NJ, 08830, US

(21) Appl. No.: 10/108,603

(22) Filed: Mar. 28, 2002

Related U.S. Application Data
(60) Provisional application No. 60/279,295, filed on Mar. 28, 2001.
(60) Provisional application No. 60/279,279, filed on Mar. 28, 2001.

(51) Int. Cl. G06F 15/173; G06F 15/16

(52) U.S. Cl. 709/223; 709/230

(57) ABSTRACT

A method of call processing includes passing, over a local area network, control signals from a centralized controller to each of a plurality of decentralized processors. The method also includes having each of the plurality of decentralized processors, in response to the control signals, executing decentralized call control functions.

### BACKGROUND

A traditional voice telephone network typically employs a circuit-switched network to establish communications between a sender and a receiver. The circuit-switched network is a type of network in which a communication circuit (path) for a call is set-up and dedicated to the participants in that call. For the duration of the connection, all resources on that circuit are unavailable for other users. An Electronic Worldwide Switch Digital (EWSD) is a widely-installed telephonic switch system. Common Channel Signaling System No. 7 (i.e., SS7 or C7) is a global standard for telecommunications defined by the International Telecommunication Union (ITU) Telecommunication Standardization Sector (ITU-T). The standard defines the procedures and protocol by which network elements in the public switched telephone network (PSTN) exchange information over a digital signaling network to effect wireless (cellular) and wireline call setup, routing and control.

A softswitch is a software-based entity that provides call control functionality. The various elements that make a softswitch architecture network include a call agent which is also known as a media gateway controller or softswitch. The network also includes a media gateway, a signaling gateway, a feature server, an applications server, a media server, and management, provisioning and billing interfaces.

The softswitch architecture does not replace an SS7 architecture. For example, when a person wants to setup a call from one location to another location, the person picks up the phone at one location and dials a set of numbers. A local switch recognizes the call as a long distance call, which then goes to a long haul exchange where it is recognized as an out of state call. The call is then transferred to a national gateway for the other location. The call then has to make a hop to an intermediate gateway, which is located somewhere between the two locations and finally the call goes through two or three switches before it connects to a local switch associated with the number. The role of SS7, which does not use traditional trunks, is to ensure prior to actually setting up the call that there is a clear path from end to end. Only when there is sufficient resources is the call set-up.

The major difference between a softswitch architecture and a traditional architecture is that the call is not required to pass through as many smaller switches. Today, when the person makes a trunk call the person uses the whole trunk even though a smaller portion of the available bandwidth is required. On the other hand, with a softswitch architecture, an Internet protocol (IP) connection between the gateways of the two locations is established and a switching fabric between the two locations is in the form of fiber optic lines or other form of trunk. There is no need to reserve trunks and set-up is not required. One only has to reserve the bandwidth that the call will need.

### SUMMARY

The inventions discussed below relate to a call processing approach that provides a distributed, open architecture telecommunications environment for addressing the needs of carriers and service providers in converging voice and data networks.

In one aspect, the invention is a method of call processing. The method includes passing, over a local area network, control signals from a centralized controller to each of a multiple of decentralized processors. The method also includes for each of the multiple processors, in response to the control signals, executing decentralized call control functions.

Embodiments of this aspect of the invention may include one or more of the following features. Passing, over a local network, control signals includes loading control data from an external device. The control data includes data associated with performing maintenance functions. The maintenance functions include centralized monitoring. The maintenance functions include a redundancy failover. The method also includes interfacing the distributed processors by tying to a set of soft switch protocols. The centralized controller is a mainframe. Passing control signals is performed using an Internet protocol. The method also includes associating at a physical layer addresses of the distributed processors with physical locations. The method includes overwriting default address with an internal address. Each of the distributed processors is associated with at least one access device. Each of the distributed processors is associated with at least one access device over a wide area network.

In another aspect, the invention is a call processing system. The call processing system includes a centralized controller to send control signals to multiple distributed processors. The system also includes a local area network to couple the centralized controller to each of the distributed processors to perform decentralized call processing.

Embodiments of this aspect of the invention may include one or more of the following features. The control signals are associated with performing maintenance functions. Each distributed processor has data physical layer addresses that are location based. Each distributed processor interface has a soft-switch architecture. Each distributed processor communicates over a wide area network to access gateway devices. The gateway devices include a voice over asynchronous transfer mode gateway. The gateway devices include a voice over internet protocol gateway. Each distributed processor has another processor that serves as a redundant partner. Each processor has a software task. The software task is an independent call-processing entity. The system also includes a packet manager interfacing with an interconnect controller. The packet manager interfaces at least one of a server, a router or a firewall. The system also includes an interconnect controller providing a bi-directional interface between the centralized controller and the distributed processors, the packet manager and signaling gateway. The centralized controller sends broadcast messages to control the processors. The centralized controller includes a local area network control and monitoring device and a call control device. The call control device interfaces with telephony signaling network. The telephony signaling network is an SS7 network. The system also includes a packet manager interfacing with the centralized controller.

Executing decentralized call control functions in response to control signals from a centralized controller provides numerous advantages. In general, call control features (e.g., call waiting three-way calling) as well as subscriber, billing, and failure control information are provided by a number of decentralized processors, each of which can operate independently and in parallel with other processors. Concurrently, the centralized controller provides overall management and maintenance of the individual processors. Using a number of decentralized processors provides a substantial increase in the event-processing capacity of the network while the centralized controller provides stable and reliable management of the processors.

By managing the individual processors from a centralized controller, modifications to call features as well as altogether new features can be introduced or “rolled-out” on a network-wide basis. For example, software upgrades can be introduced from the central controller without risk of disturbing legacy features that customers wish to maintain. The decentralized processors are controlled by the centralized controller to provide back-up in the event of failure by any of the processors. Such modifications and additions are transparent to the customer. The system architecture and operation allows customers to migrate more smoothly to today's converged networks.

The system architecture is particularly well suited in allowing the high quality and variety of voice services of real-time voice networks to be transferred to data networks, and conversely enables IP applications to be used in the voice network. The open architecture is fully scaleable and offers flexibility by supporting existing legacy systems, while allowing the introduction of newer call feature services.

### DESCRIPTION OF THE DRAWINGS

FIG. 1 is a block diagram of a multiservice switch architecture.

FIG. 2 is a block diagram of a media gateway controller and call feature server.

FIG. 3 is a block diagram of a packet manager.

FIG. 4 is a block diagram of inter-connect controller (ICC).

FIG. 5 is a diagram of a side of a converter board.

FIG. 6 is a block diagram of an interconnection between a inter-connect controller and a network services processor.

FIG. 7 is a block diagram of local area network (LAN) components.

FIG. 8 is a block diagram of media control platform (MCP).

FIG. 9 is a diagram of a minimum MCP shelf configuration.

FIG. 10 is a diagram of a maximum MCP shelf configuration.

FIG. 11 is an MCT Communication Table.

FIG. 12 is a Command Distribution Table.

FIG. 13 is a table of an address conversion on MCP 28.

### DETAILED DESCRIPTION

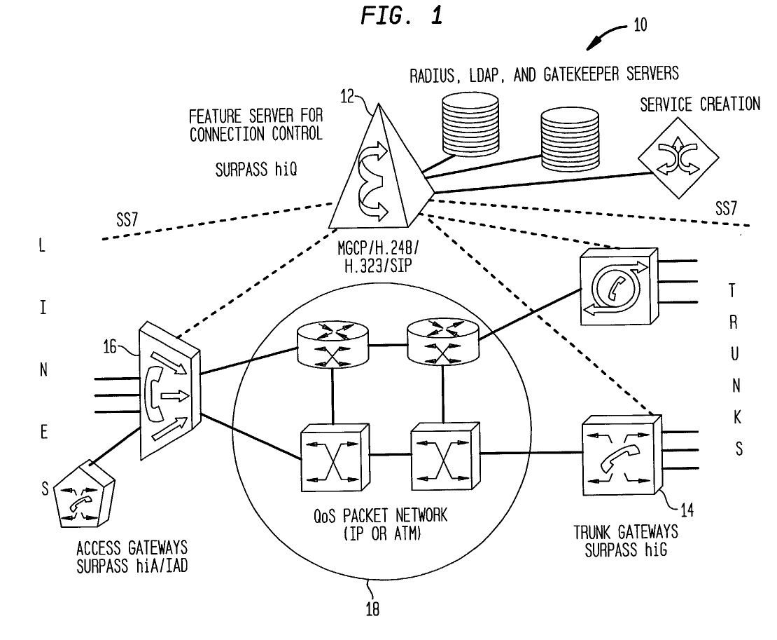

Referring to FIG. 1, a multiservice switch (MS) architecture 10 includes a softswitch controller 12 for providing signaling and control functions, a gateway 14 for providing trunk gateway functions, and an access platform 16 for providing line access functions. Softswitch controller 12, gateway 14 and access platform 16 are networked together with a core packet network 18 with quality of services (QoS) characteristics to provide all services which include multi-media and data and voice.

As will be described in greater detail below, softswitch controller 12 provides control inter-working between public switched telephone network (PSTN) and packet-based networks, and implements voice services and feature transparency between PSTN and packet networks. Since softswitch controller 12 interfaces different media, softswitch controller 12 uses different protocols in order to communicate with the different media. For example, softswitch controller 12 uses a Media Gateway Control Protocol (MGCP), an ITU-T (International Telecommunications Protocol) H.323 protocol, Bearer-Independent Call Control (BICC), Remote Authorization Dial-In User Service (RADIUS) protocol and SS7. MGCP is used by softswitch controller 12 to centrally control voice over packet gateways and network access servers. The ITU-T H.323 protocol is a set of signaling protocols for the support of voice or multimedia communication within a packet based network (e.g., IP networks). The ITU-T H.323 protocol covers the protocols necessary for operation and for interconnection with circuit switched networks. BICC is the protocol used between softswitch controller 12 to exchange local information regarding call setup. RADIUS is the standardized protocol for Internet access control. SS7 is the world-wide standard for common channel signaling in the network.

Gateway 14 bridges the gap between packet-based networks and PSTN. Gateway 14 is controlled by softswitch controller 12 and provides the media stream conversion between a time division multiplex (TDM) network and Internet Protocol (IP) or from an asynchronous transfer mode (ATM) network.

Access platform 16 provides access technologies from existing Plain Old Telephone Service/integrated Services Digital Network (POTS)/(ISDN) to generic Digital Subscriber Lines (XDSL) and other broadband services such as Frame Relay ATM as well as Voice over IP (VoIP) access gateways.

Unlike a traditional switching architecture consisting of signaling and call control, trunk access, line access and a switching fabric all residing in one box, MS architecture 10 provides all the same functions found in a traditional architecture, as well as others, but distributes these functions over a network. Thus, softswitch controller 12 performs the signaling and controlling functions, access platform 16 and gateway 14 functionally perform the trunk/line access and QoS packet network 16 performs the function of the switching fabric.

Many factors are considered when developing the system architecture for softswitch controller 12. One of the most important factors which drives the architecture development is the requirement that softswitch controller 12 support the full Class 5 feature set. To accomplish this goal, full advantage is taken of the existing, very stable Digital Switching System (EWSD) feature software. This re-use has the immediate advantage that the required features are already available in a tested, stable environment. Therefore, a server architecture 20 for softswitch controller 12 fits within the framework that allows for the development of a platform which has minimal impact on the required feature set. An additional critical factor to consider is the rate at which technology is constantly improving and evolving. Any server architecture which is developed therefore, will use commercially available platforms (where possible) so that significant improvements in throughput and capacity may be realized by upgrading the platforms as the improved technology becomes available. Lastly, the call model and capacity issues are incorporated into the architecture design.

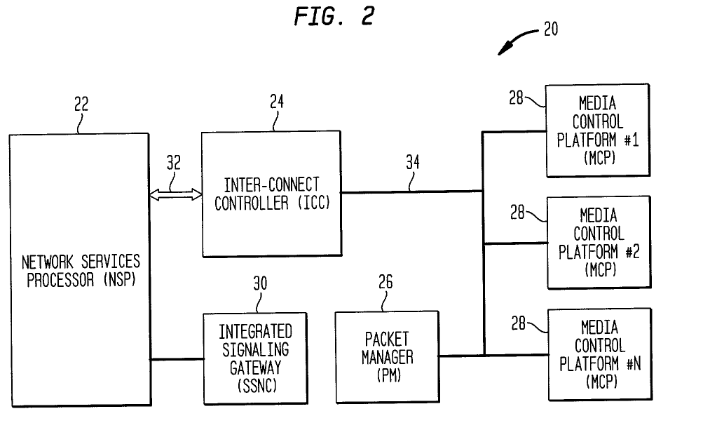

Referring to FIG. 2, softswitch controller 12 has a server architecture 20 which can be thought of as having seven functional parts, namely, a Network Services Processor (NSP) 22, an Inter-Connect Controller (ICC) 24, a Packet Manager (PM) 26, a set of distributed Media Control Platforms (MCPs) 28, an Integrated Signaling Gateway (ISG) called a Signaling System Network Control(SSNC) 30 and lastly, a connection medium which allows all of the functional blocks to communicate with one another. The connection medium is split into two entities, namely, a first connection 32 between NSP 22 and ICC 24 and a second connection 34 between ICC 24 and distributed platforms 28.

In this embodiment, architecture 20 supports 4,000,000 busy hour call attempts (BHCA). However, for the purposes of call model calculation, architecture 20 can support up to 250,000 trunks. When a mean holding time of 180 s/call is used for 250,000 trunks (125,000 incoming and 125,000 outgoing) this equates to 2,500,000 BHCA (or 695 calls/s).

A. Common Media

First connection 30 between NSP 22 and ICC 24 is an 8-bit serial interface (proprietary) which mimics an input/output processor:message buffer (IOP:MB) to Message Buffer interface. This interface is completely realized in the hardware (HW). Second connection 34 is between ICC 24 and the system periphery (MCP 28, PM 26, and NSP 22). This connection is realized using a Fast Ethernet (100 MB/S) LAN segment. The EWSD HW based addressing algorithm will be converted to a standard IP based addressing scheme.

B. SSNC Overview

SSNC 30 performs the signaling gateway functionality. SSNC 30 is a multi-processor system consisting of a single shelf (minimum configuration) of HW. SSNC 30 is its own system with its own maintenance devices disks and optical devices. It is “loosely coupled” to NSP 22 via an ATM30 link and to the local area network. SSNC 30 performs the task of terminating the SS7 from the network and converting the signaling into server compatible messaging. SSNC 30 further controls the routing of messages to NSP 22 or media control tasks (MCTs). Further, SSNC 30 will route SS7 messages from softswitch controller 12 to the network. SSNC 30 terminates pure SS7 links. In other embodiments, the SS7 links will be replaced by stream control transmission protocol (SCTP) associations. SSNC 30 consists of the following HW: a main processor: Stand Alone (MP:SA), an ATM Multiplexer (AMX), an ATM central clock generator (ACCG), an alarm indicator (ALI), link interface circuit (LIC), along with associated small computer system interface (SCSI) disks and optical drives. The MP:SA is the system master and performs the control functionality such as OA&M, loading, for example. The AMX provides the connectivity between system pieces, i.e., allowing all of the units to communicate with one another via a proprietary asynchronous transfer mode (ATM) protocol called Internal Transport Protocol (ITP). The MP:DEP performs the Signaling Link Termination (SLT) functionality. It is responsible for the SS7 handling. The ACCG is the source of the system clock. The ALI provides the alarm interface for the system. Additionally, it provides the interface for the radio clock reference signal (i.e., network reference). The LICs provide the termination for the SS7 links. The LICs will in the future be replaced by MP:DEP-E (Ethernet) for Stream Control Transmission Protocol (SCTP) termination.

C. PM Overview

PM 26 provides the interface to the Media Gateway for the server architecture 20 the incoming signaling is done via ISDN Signaling User Part (SS7), BICC and MGCP messaging. The platform HW is realized using a commercially available Sun FT1800 fault tolerant system detailed below. Connection to softswitch controller 12 is done via redundant Ethernet paths on the LAN. PM 26 is an external device which is not fully integrated into server architecture 20. PM 26 is totally decoupled from softswitch controller 12 as far as any recovery, configuration, or maintenance strategy.

There is a form of loose coupling which is realized by a periodic message sent from NSP 22 to PM 26 via each redundant LAN segment. PM 26 responds to this message on each LAN side. The purpose of this messaging is two-fold in that it serves to inform NSP 22 that PM 26 is still available and secondly, the message from NSP 22 to PM 26 contains the active LAN side so that PM 26 knows which LAN side to use when transmitting to NSP 22 and/or any other peripheral platform.

D. PM HW Configuration

The PM system configuration is a variant of previous PM configurations with specific modifications to support the required dual Ethernet connection. This is the only PM modification required for compatibility with the call feature server (CFS) architecture.

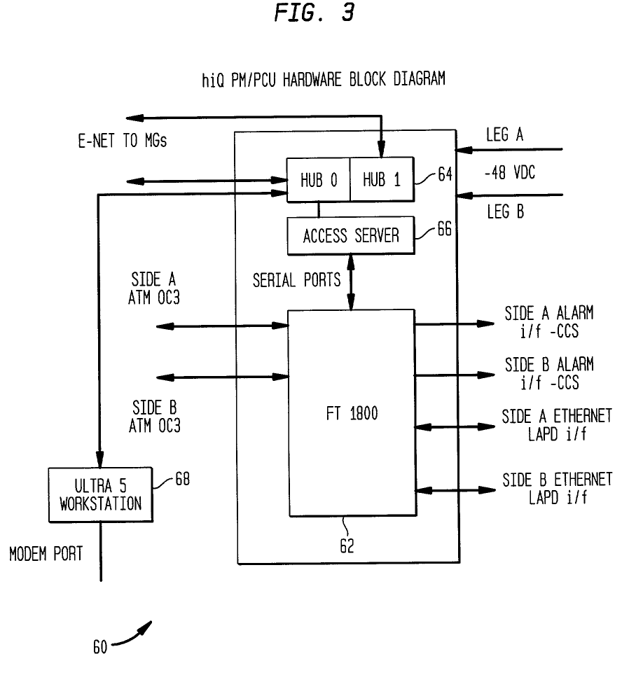

Referring to FIG. 3, the PM system configuration 60 consists of a single rack of equipment and a free standing, local management workstation. PM hardware suite 60 includes one rack mounted Sun Microsystems Netra ft 1800 subsystem (−48 VDC) 62, two rack mounted Garrett DS880 10/100 Ethernet hubs (−48 VDC) 64, one rack mounted Cisco 2611-DC access server (−48 VDC) 66, and one free standing Sun Microsystems Ultra 5 workstation (110 VAC) 68. Subsystem 62 is the core component of PM 22 and is configured as follows in a PM Dual Processor system configuration: one main system chassis, two 300 MHz CPUSETS with 512 MB memory (one per side), two hot plug 6 slot disk chassis (one per side), four 18 GB disk drives (two per side), two removable Media Modules with a compact disk read only memory (CDROM) and Digital Audio Tape (DAT) tape drive (one per side), two 8 slot hot plug Peripheral Component Interconnect (PCI) chassis (one per side), two Console, Alarm, Fan (CAF) modules (one per side) each with two Ethernet ports (net0/1), one console port, one Remote Control Port (RCP), one modem port, four 10/100 Ethernet PCI cards (two per side) (two for softswitch Ethernet, two for dual attach EWSD Network manager (ENM) Ethernet), two 155 MB OC3 ATM PCI cards (one per side), and four hot plug power modules (two per side). In other embodiments, the basic Dual Processor configuration may be optionally upgraded to a quad processor configuration for increased performance.

Subsystem 62 is a hardware fault tolerant subsystem. This is achieved by the dual sided hardware architecture of subsystem 62 that enables both sides to operate in lock-step I/O synchronization (combined mode), and also independently (split mode). This architecture also provides fault isolation and containment with respect to hardware failures within subsystem 62.

The configuration of subsystem 62 used in PM 26 is designed to withstand failures in a single hardware component. All electrical components, CPUSETs, I/O devices, PCI buses are duplicated, and are hot replaceable by design. Failure of a single I/O device (ATM card, LAPD i/f card, Ethernet card, disk, tape drive, etc), CPUSET, or power module will not bring the system down. Furthermore, failure of a single I/O device will typically not bring a side down.

Software faults do have the potential to bring the entire system down when operating in combined mode since the both sides will experience the same fault due to the lockstep operation of subsystem 62.

A single Cisco Access Server provides a mechanism for terminating serial port connections from Subsystem 62 and provides external access to these serial ports via an Ethernet connection for maintenance and control operations. These serial ports are: Side A console port, Side A Remote Control Processor (RCP), Side B console port and Side B Remote Control Processor (RCP). Two (2) Ethernet 10/100 auto-sensing hubs are included in the PM system configuration to provide redundant external network connections and support for the PM's internal network. All subsystem 62 Ethernet connections are configured as dual attach Ethernet connections (connected to side A and Side B with auto failover) yielding fault tolerant Ethernet network connections except for the two softswitch Ethernet connections. The softswitch Ethernet connections do not require dual attach functionality since redundancy is handled by the OpEt software.

Workstation 68 is a standard Sun Microsystems off-the-shelf workstation product. Workstation 68 functions as the local management station for controlling the PM frame during software installations, upgrades, and repair operations. A dial-up modem is also supported on workstation 62 for emergency remote access.

E. NSP Overview

NSP 22 is realized utilizing the hardware of the EWSD CP113C. The hardware is robust, stable, fault tolerant and provides a “ready-made” environment to ensure that the feature rich EWSD call processing software will run without problems. The hardware consists of standard EWSD CP113C HW up to and including the input/output (I/O) interfaces. This includes base processors (BAP), call processors (CAP), common memory (CMY), bus for CMY (B:CMY), input/output controllers (IOCs) and input/output processors (IOPs) and the existing storage media (MDD)is supported as well.

The role of NSP 22 is to provide the feature/Call processing process (CALLP) database. NSP 22 also performs the loading of necessary data to the distributed MCPs 28 and perform those coordinated functions necessary to keep the system operational (e.g., maintenance, recovery, administration, alarming, etc.). The advantage of using the CP113C hardware is clear. All of the necessary functionality exists and can be re-used with a minimum set of changes (as opposed to a re-implementation). One further advantage of this re-use is the fact that all of the existing operations support systems (OSS) can be supported.

F. ICC Overview

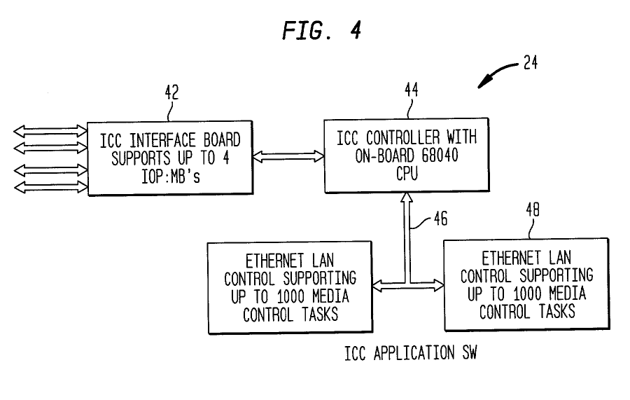

Referring to FIG. 4, ICC 24 is a multifunctional unit. ICC 24 provides a bi-directional interface between NSP 22 and the distributed platforms 28, PM 26, and Signaling Gateway 30. In addition to providing the interface, it provides the protocol conversion between standard EWSD messaging (i.e., message buffer unit/message channel (MBU/MCH) based addressing) and Ethernet Media Access Control (MAC) addressing (discussed in detail below), since the actual platform interconnect will be provided via fast Ethernet (100 MB/s internal local area network (LAN) segment(s)). ICC 24 handles the routine test interface from NSP 22. This is necessary to satisfy the hardware/software (HW/SW) interface which requires the functional buffering/switching devices (switching network (SN) and message buffer (MB) from the EWSD architecture) to be present. Lastly, it supervises the LAN interface (i.e., reflect the connection status of the distributed platforms 28 to NSP 26), detect any LAN faults and report any faults to NSP 22.

ICC 24 performs inter-platform routing for any distributed platform. Thus, whenever a peripheral platform (including devices: MCP 28, PM 26, and Signaling Gateway 30) communicates with a second (or multiple) peripheral platform(s), the message is sent to ICC 24 and ICC 24 reroutes it to the required destination. This is necessary to offload NSP 22 since the above mentioned messages would normally be routed via NSP 22. This bypass provides NSP 22 with additional capacity. In other embodiments, the devices communicate with one another directly and ICC 24 merely monitors each device and informs the other devices of any status changes.

The ICC 24 has the following functional blocks. An interface board 42 is a pure HW component which addresses the signaling interface between CP113C IOP:MB, an 8-bit parallel interface, and ICC 24. Interface board 42 connects directly with a controller board 44 which acts as a multiplexer. One controller board 44 supports up to eight interface connections and therefore by extension, eight IOP:MB interfaces. If additional IOP:MB interfaces are supported, for example, up to 7 are required to support 4,000,000 BHCA, then this is accomplished by adding interface boards 42 (which support up to 4 interfaces) and/or controller boards 44.

The next functional block is the application SW 46 itself. Application SW 46 communicates with the controller board via Direct Memory Access (DMA) (bi-directionally), so that NSP messages may be received and sent. Lastly, a LAN controller 48 provides the actual interface to MCPs 28, PM 26, and Signaling Gateway 30. The application entity therefore provides the bi-directional connection path between NSP 22 format messages and the Ethernet messages.

The ICC HW is realized by using a standard slot based 500 MHZ Pentium III (or better) CPU slotted into a passive backplane. The Interface card HW 42 requires a standard Industry Standard Architecture (ISA) connection, while the Controller HW 44 uses a peripheral component interconnect (PCI) slot. The LAN controller(s) 48 also use standard PCI interfaces.

G. ICC HW

Softswitch controller 12 development ICC 24 is a PC based system. It converts NSP 22 I/O system (IOP:MB) to the PCI-BUS standard which is used in a PC environment. Generic PC-boards can be used to further process NSP 22 data and send it via NIC to the LAN which connects all units involved in the data exchange.

ICC 24 is housed in rack mountable case that holds the different PC-boards to assemble ICC 24 functionality. Due to redundancy, two ICCs 24 are needed. To connect both the ICC with NSP 22, the SPS frame is required. The frame contains converter boards and the necessary cables to hook up the ICC with NSP 22.

There are 2 ICCs 24 each housed in 4U case with 12 slot passive backplane. Each ICC 24 contains one Slot CPU, two NIC, two switching periphery simulator B board (SPSB) controller boards, two switching periphery simulator C board (SPSC) interface board, two switching periphery simulator D board (SPSD) port board, one SPS frame is with four switching periphery simulator E board (SPSE) converter boards.

In other embodiments, each ICC 24 contains one Slot CPU, one network interface card (NIC), one switching periphery simulator B board (SPSB) controller board, one SPSC interface board, one SPSD port board, one SPS frame with two SPSE converter boards.

The Slot CPU with a Pentium III, 1 GHz runs the control SW under Windows98/Linux. Currently 512 Mbyte system memory is sufficient to execute the SW applications.

The LAN board (NIC) is the interface to the LAN which enables communication with the PM/PCU and the MCPs. This network interface card is a commercial board which holds it's own CPU. An intelligent server adapter suitable for this embodiment is the PRO/100 manufactured by Intel. The on-board CPU takes over a lot of load balancing and LAN maintenance tasks which will free up the PC-CPU for more important duties.

The controller board (SPSB) communicates with the PC SW via bus master DMA and with NSP 22 via the interface boards. The controller board contains a MP68040 with 25 Mhz bus clock, an interface to the PC memory using DMA via PCI bus, a 32-bit interface to the outside of the PC realized with a 37-pin sub-d connector (10-PORT) for testing and controlling purpose, an interrupt input for the MP68040 (one pin of the 37-pin sub-d connector), a clock, reset, grant, address and data bus to four SPSC boards where the SPSB can control up to four SPSC which allows the connection of sixteen IOP:MB interfaces, a 256 Kbyte RAM, no wait state access, and a 256 Kbyte Flash memory (2 wait state access which holds the FW for the 68040 CPU).

The interface board (SPSC) has a connection with NSP 22. The board includes four interfaces to IOP:MB, two interfaces are accessible via 26-pin high density sub-d connector located on SPSC board. The other two interfaces need to be connected via two 26 pin ribbon cables with the SPSD board. The board also includes a counter for central time stamp with a resolution of 1 us.

One board holds four IOP:MB interfaces which will be sufficient for up to 60 k trunks. If more trunks are needed another interface board is added so that 250 k trunks can be supported.

Port board (SPSD) serves as a port to the outside since only two 26 high density (HD) sub-d connectors fit on board SPSC. The SPSC however allows the connection of four IOP:MB and therefore the missing two connectors are placed onto SPSD. SPSD holds only passive components, two connectors for two 26 pin ribbon cables and two 26 HD sub-d connectors.

SPS FRAME (SPSSF) is mounted in the ICC rack and holds up to 4 converter boards (SPSE) which translate up to sixteen IOP:MB interface signals to/from TTL/bipolar. All necessary cables are connected between IOP:MBs, SPSSF and ICC 24 which creates a compact device.

CABLE (B) connects one IOP:MB interface of the ICC, with the SPS frame (SPSSF). It plugs via 1-SU SIPAC connector into the SPSSF back plane and with a 26-pin SUB-D connector into one IOP:MB interface on the ICC. The SPSSF feeds the signals from cable (B) to SPSE which is used to exchange data/control information between the ICC and the IOP:MB.

CABLE (X) is a Standard cable between IOP:MB and MB. This cable has a 1-SU SIPAC connector on both sides and connects the SPSSF with the IOP:MB.

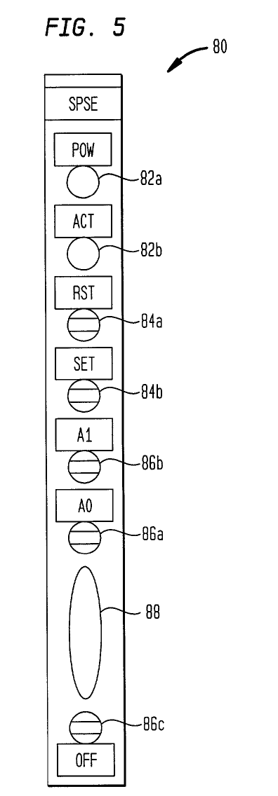

Referring to FIG. 5, Converter board (SPSE) 80 supports four IOP:MB interfaces and converts the signals between TTL and bipolar since ICC 24 needs TTL signals and the IOP:MB uses bipolar signals. There are two light emitting diodes (LEDs) (green LED 82a and red LED 82b), two toggle switches (reset switch 84a and set switch 84b), three switches (an address-0 switch 86a, an address-1 switch 86b and a power switch 86c) and one 37-pin connector 88 located on the front of SPSE. Green LED 82a indicates available power if lit and the red LED 82b shows that at least one request address from the IOP:MB is switched to ICC 24. Set toggle switch 84b forces all request address (A0, A1, A2) of all four IOP:MB interfaces to be switched over to the ICC, this has to be done after every power on of SPSE. Reset toggle switch 84a clears all register on SPSE and no request will be sent to ICC 24, and is used for test only.

The A1 and A0 switches select the board interface number (0,1,2, or 3) which can be traced by connecting the interface tracer (IFTR) to 37-pin connector 88.

| A1 | A0 | interface number |
|---|---|---|
| Down | down | 0 |
| Down | up | 1 |
| Up | down | 2 |
| Up | up | 3 |

A 37-pin sub-d connector female is the interface for the IFTR-Tracer. Power switch 86c turns the power on and off. The SPSE contains a set of four DIP switches per IOP:MB interface which are switched on for proper signal termination.

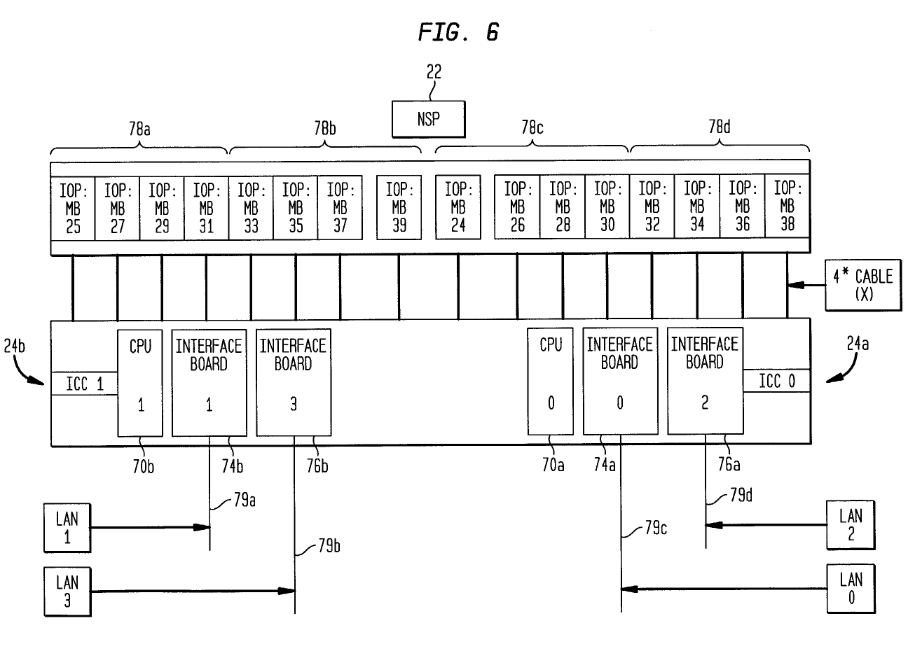

Referring to FIG. 6, each ICC 24a and 24b is a compact PCI (CPCI) based system. It comprises a generic CPU board with Intel Pentium III CPU 70a and 70b with 1 Ghz, 512 Mbyte Memory and up to two interface boards 74a-b and 76a-b for connecting with NSP 22. The two ICCs 24a and 24b are housed in one shelf with compact PCI back plane. Two Interface boards connect up to four IOP:MB from NSP 22 and one 100Base-Tx Ethernet port. For example, board 74a connects to IOP:MB 78c and port 79c; board 76a connects to IOP:MB 78d and port 79d; board 74b connects to IOP:MB 78a and port 79a: and board 76b connects to IOP:MB 78b and port 79b.

H. Local Area Network Components

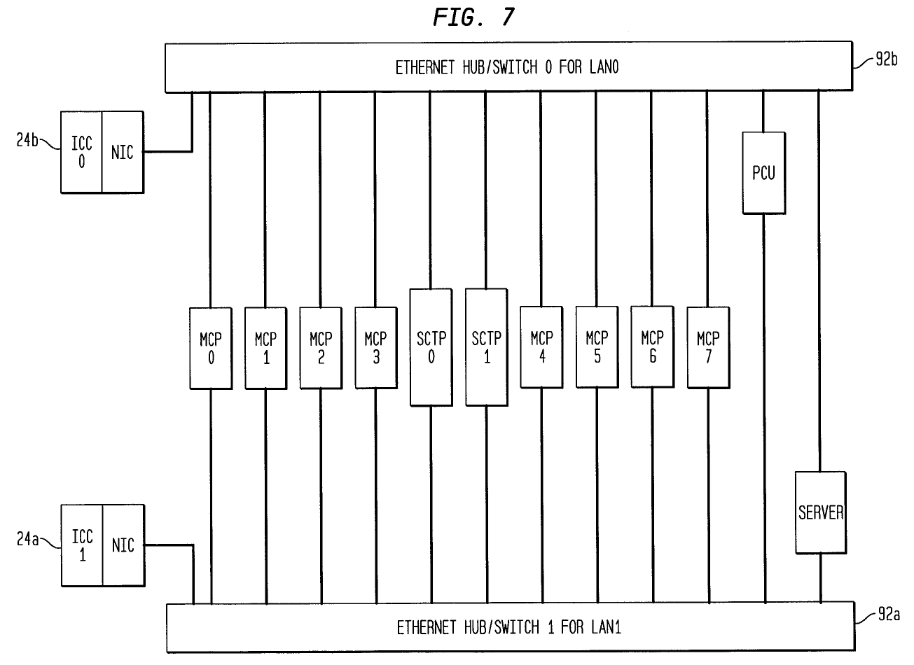

Referring to FIG. 7, the LAN is a 100Base-TX Ethernet that interconnects all system components. All units hooked up to an Ethernet hub/switch, a hub is usable up to 1M BHCA and has to be replaced by a switch for greater than 1M BHCA. A switch is used even for the 1M BHCA system, since the extra bandwidth offers a higher quality of service.

Two 100Base-TX Ethernets 92a and 92b are used for each ICC 24a and 24b to connect all units via LAN. The two LAN segments are needed to support enough bandwidth between the ICC and MCP 28. There are at least 23 units hooked up to one LAN segment (ICC, PM/PCU, sixteen MCPs, four SCTPs, Router for OAM&P and SG). For redundancy reasons, four independent LAN segments are employed. (Two for side0 and two for side1).

I. MCP Overview

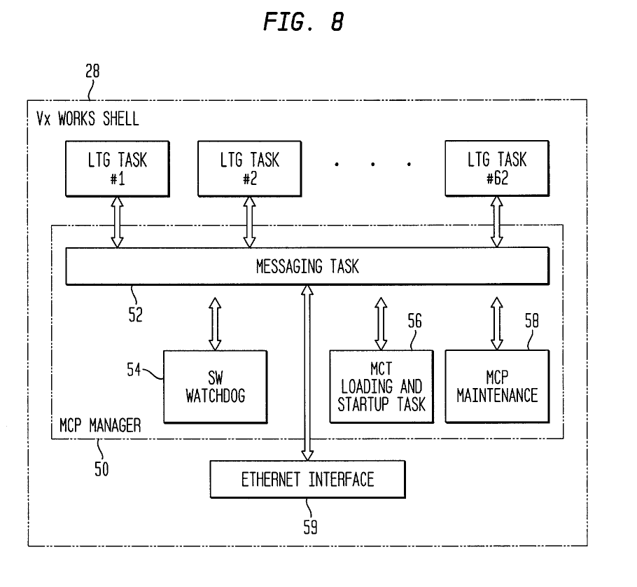

Referring to FIG. 8, MCP 28 consists of a slot based central processing unit (CPU) (Pentium III 500 MHZ or better) in a backplane. MCP 28 provides a platform for media control functions, which work with the software in NSP 22 to provide media control features. MCP Software is divided into the following two functions: Media Control Functions and MCP Manager Functions 50. Each MCP 28 supports up to 62 Media Control Tasks (MCTS) running simultaneously under a real-time operating system (VxWorks). Each MCT is an independent call-processing entity. EWSD Line Trunk Group (LTG) software is reused extensively to provide the MCT function.

MCP Manager Functions 50 are distributed across a messaging task 52, software watchdog task 4, a MCT Loading & Startup Task 56, and a MCP maintenance task 58.

Messaging task 52 is multi-functional. It provides the interface to the Ethernet for communication between all tasks on MCP 28 and NSP 22 or other distributed platforms. It also provides an interface with ICC 24 for maintenance of the LAN and the message channels associated with the Media Control Tasks.

SW Watchdog task 54 is responsible for monitoring all MCP tasks to ensure that each task is running correctly. MCT Loading & Startup Task 56 provides an interface to NSP 22 for loading of MCT software. It is also responsible for managing and manipulating the context associated with each MCT, and for generating each MCT task in its correct context. MCP Maintenance Task 58 performs general maintenance functions on MCP 28, including handling reset requests from NSP 22, routine test and audit functions, utilities and processing firmware upgrades. MCP Manager Functions are further explained below.

J. MCP Hardware Configuration

MCP 28 replaces the existing LTG hardware and software. MCP 28 supports 62 Virtual LTG images under control of a commercial Operating System (i.e., VxWorks) along with the necessary messaging and support tasks. The MCP hardware requirements will support WM requirements and US.

The Media Control Processor (MCP) hardware and Operating System is based on commercially available products. The overriding requirement for the Hardware is that it be (US) Central Office ready or NEBS Level 3 compliant. The key components are the MCP Processor Board, Ethernet Switch, Chassis/Backplane, and Rack.

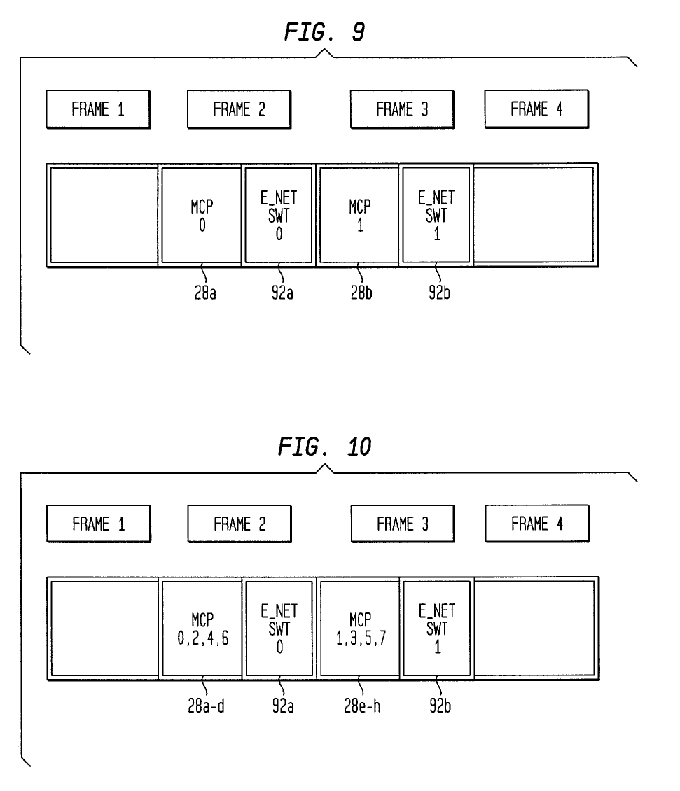

Referring to FIGS. 9 and 10, the R1.0 minimum MCP shelf configuration has four 5-slot enclosures, one redundant pair of MCPs 28a and 28b, and two Ethernet switches (for sides 0 & 1) 92a and 92b. The R1.0 maximum MCP shelf Configuration has four 5-slot enclosures, four redundant pairs of MCPs 28a-h or eight MCPs and two Ethernet switches (for sides 0 & 1) 92a and 92b.

1. MCP Processor Board

The MCP Processor Board will plug into a passive Backplane. It will receive power and the board location (shelf/slot) from the Backplane, and all connectivity and communications is achieved through the Ethernet ports. It may be also possible to use a Backplane Ethernet bus. The processor on the board is a x86 because the ported code is in Intel assembly language.

The processor board (PB) is a single computing board (SBC) platform, single slot computer platform. The processor board has the following characteristic. The PB Size fits into a chassis that fits into an EWSD Innovations Rack (BW Type B). The PB pitch size or width is used for calculating the estimated heat dissipation, approximately 1 mm of pitch/1 watt. Boards are hot swappable. The boards have a Intel (x86) processor and Cache size: Minimum size 256K at full speed.

PB has a high performance CPU/Bus/Memory having a CPU >500 MHz core frequency, 133 MHz system bus frequency and a Highspeed SDRAM (e.g., 10 ns). The Memory size is 768 Mbytes to 1 Gbytes, in steps expandable.

PB has error detection and correction for memory. PB has flash memory size of at least 32 Mbytes used as a boot source (i.e., no hard disk) and is field upgradable. Other features include, a HW watch-dog (2-stage: Stage 1—Soft, Stage 2—Hard), a HW Timer (1 ms; 100 ms granularity), BIOS Support; Boot from Flash (including board test and diagnostics), Hard or Soft Reset Capability, Real-time OS Board Support Available (e.g., VxWorks), low power dissipation less than 20 Watts and MTBF greater than 10,000 FIT (MTBF less than 11 years), and backward compatibility for next generation boards, (i.e., pin compatibility, reuse of existing shelf).

The SBC External Interface features include 2×10/100 Mbit/s Ethernet interfaces (i.e., dual Ethernet ports integrated on processor board), Cabling with rear accessible Interfaces, debug interfaces with Front access (e.g., RS-232, USB), board status visual indicators (Front Access, red/green LED's), and board reset push button (Front Access).

2. Ethernet Switch Board

An Ethernet Switch is required over the use of a hub. The traffic (synchronization issue) requirements will begin to saturate the fast Ethernet when 500 LTGs are supported. When more than 2,000 LTGs are supported, the switch will become more important. The Ethernet Switch Board is an off-the shelf cPCI product.

The Ethernet Switch Board Type has a self-learning feature and 24 ports with 10/100 Mbit/s each. 16 ports are connected via cabling (rear connection, e.g., RJ 45) with the 16 processor boards and 8 ports are connected via connectors (rear connection, e.g., RJ 45) for inter shelf connection. The Ethernet board also has hot swappable boards, power dissipation for a single slot board greater than 20 watts for a double slot board is less than 40 watts and MTBF less than 10,000 FIT (MTBF greater than 11 years).

3. Chassis/Backplane

The Shelf(Chassis) includes a Backplane and Power Supply.

The shelf or chassis will house the SBCs, Power supplies, and the Ethernet Switch board, and will be mounted in a rack. The Shelf Power Supply Type has redundant power supply (−60; −48 V) for 16 Pro+2 Switch Boards per shelf, N+1 redundancy, hot swappable power supply boards, and MTBF less than 10,000 FIT (MTBF greater than 11 years).

The Shelf and Backplane Type is packaged has having ≧16 processor boards+2 Switch Boards+Power supply in one shelf. The Backplane is split for repair and replacement, a split Backplane solution will double the power supplies required for redundancy. The Backplane has Shelf and Slot indication readable by the SBC for location identification.

The rack supports 4 shelves or greater per rack (7 ft rack), EWSD-mod rack size BW-B Rack, and has a rack power dissipation less than 3.5 kW.

The following section describes the Shelf/Backplane and Rack, Single Computing Boards, and Building Practices required for the system.

The Shelf/Backplane provides power, a shelf and slot identifier, and pass environmental test as required by our customers (i.e., NEBS Certification). In order to support redundancy, repair, and upgrade procedures the Backplane is split. It is possible to remove a faulty Backplane for repair without losing any stable calls in the system. Redundant Power Supplies are required for fault, upgrade, and repair situations.

A minimum of 4 shelves fit into the Rack and the alarms and fuses are integrated into the Rack. The fans contribute heat dissipation and are incorporated into the shelf/rack configuration. The Backplane/Shelf combination supports a minimum of 16 processor boards, redundant power supplies, and an Ethernet Switch. Cabling is done at the rear of the shelf. The rack suitable for this embodiment is manufactured by Innovations Rack (BW Type B).

There will not be any disk on the SBC; an internal RAM-disk or flash memory will be used for booting the system.

The MCP boards communicate via a 100 Mbit Ethernet interface for internal synchronization data and communications to the MBD-E. The internal LTG data synchronization is required for the LTG redundancy scheme, a fail-over design. In order to support the message throughput required for a 240K (or greater) trunk system it will be necessary to incorporate an Ethernet Switch, which will keep the synchronization traffic off of the communication connection to the MBD-E.

There are three configurations can be used for small, typical, and large system definitions. For a small configuration, two to four MPCs 28, MCP 28 can be directly connected to the MBD-E platform. For a typical configuration, 240K trunks, a single stage Ethernet Switch can be used. For a large configuration, greater than 240K trunks, a second level of Ethernet Switches will be required. All the configurations are redundant for availability, upgrade, and repair.

The realtime operating system (OS) supports running dual operating systems, full register save/restore on a context switch. The OS has a full suite of off the shelf support packages to support the hardware bringup. (Board Support Packages).

K. System Redundacy

Softswitch controller 12 is a fully redundant, fault-tolerant system. NSP 22 is realized using the CP113C HW from the existing EWSD configuration. Since this is already a fault tolerant system, no extra development is required to ensure redundancy in NSP 22. The ICC/LAN redundancy is realized due to the fact that two copies of each exist (side 0 and side 1). A failure of one unit automatically causes a switchover to the secondary unit (without any service interruption). This is handled via the Fault Analysis SW (FA:MB is adapted to handle ICC) running on NSP 22. The LAN itself uses a “productive redundancy” concept. This means that both LAN sides are active but each carries half the traffic (this is accomplished with no additional development effort by using the standard LTG message channel distribution (i.e., each task has a different default active/standby side). If a LAN failure occurs, the switchover causes the remaining LAN to carry the full traffic load. MCP 28 itself is not a redundant platform, however, since the MCT SW supports redundancy (LTGC(B) concept), it is possible to make each MCT redundant. This is realized by distributing the MCTs in such a way that each task has a partner which runs on a different MCP. Thus, the failure of a single MCT results in its functionality being taken over by the “partner” board. The failure of a MCP board results in the switchover of each MCT being carried by that board. The SSNC redundancy is realized at a HW level but in a different manner than within NSP 22. Each unit (e.g., MPU) has a redundant partner. For example, MCPs 28 consist of two MPUs which run micro-synchronously. This same concept applies to AMX, ACCG, ALI-B and LIC. The concept of a system half does not exist within SSNC 30. The redundancy therefore is realized on a per unit basis.

L. MCP Detail

As explained above MCP Manager software 50 provides support functions for the media control tasks that operate on the MCP. Messaging Task 52 provides the communication interface between MCP tasks and two Ethernet LAN interfaces 59 of MCP 28. All incoming Ethernet messages are routed to Messaging Task 52. Messaging task 52 examines each message and determines the appropriate target task based on the encapsulated message header (Destination MBU, Destination MCH, Jobcode 1 and Jobcode 2). Interfaces in Messaging Task 52 allow other tasks to send messages out over the LAN. These interfaces perform address translation between the requested EWSD destination address (MBU/MCH) and a corresponding Ethernet address. Messaging Task functions 52 are described in further detail below.

Software Watchdog Task 54 monitors all the tasks that operate on the MCP. The main function of SW Watchdog task 54 is to detect when a task has ceased to function properly due to a software error. When a failed task is detected, Software Watchdog 54 takes corrective actions, depending on the type of task that has failed.

MCP Maintenance Task 58 performs several functions that are related to the operation of the MCP platform. The main function of MCP Maintenance task 58 is to provide an interface to a Coordination Processor (CP) for configuration and testing, and to perform periodic monitoring of MCP hardware. It also provides interfaces for utilities and for the MCP firmware upgrade function. The functions of MCP Maintenance task 58 are separated into three sub-tasks: a high priority Maintenance task, a low-priority Maintenance task and a background-testing task. The high priority task performs time critical activities such as fault reporting, configuration etc. The low priority task performs non-time critical functions such as upgrade and MCT patching. The background-testing task executes at the lowest system priority and performs functions such as routine testing and audits.

MCT Loading & Startup Task 56 is responsible for starting and managing the MCTs. It provides an interface to NSP 22 for loading and patching MCT software. It also builds the context associated with each MCT (data memory, descriptor tables etc.) and can generate or kill a given MCP task.

In addition to the above task functions, there are several software functions that are performed, but which are not associated with a specific task. A system startup function initializes the MCP Manager tasks 52, 54, 56 and 58, as well as all hardware and other resources used by the MCP Manager 50.

A context switching function loads and saves MCT context information during task switches. This information is in addition to basic context information that is saved by VxWorks. A timer function provides a periodic clock update to each MCT. An MCT Interface Functions provides a way to interface between the MCT and the MCP Manager software, via call gates. These are mainly used for message transmission and reception in the MCT. A signal handling function provides a means to detect and recover from MCT exceptions detected through the normal VxWorks exception-handling mechanism. This replaces the interrupt service routines that handle exceptions within existing MCT software.

The following describe the actions required of the MCP Manager tasks, in the context of the high-level functions that are performed on MCP 28. These include MCP initialization, MCP recovery and configuration, MCP operation, MCP messaging, fault detection, MCP Patch function, MCP upgrade, and MCP utilities.

The MCP Initialization includes MCP boot and VxWorks-start-up. During MCP Boot, at power on (or CPU reset) the BIOS (after the power-on self test is passed) invokes a routine called romInit. The romInit routine disables interrupts, puts the boot type (cold/warm) on the stack, performs hardware-dependent initialization (such as clearing caches and enabling DRAM), and branches to a romStart routine. The romStart routine copies the code from ROM to RAM and executes a routine usrInit, which is just copied. The routine usrInit initializes all default interrupts, start the kernel and finally starts a “root task” (usrRoot), the first task running under the multitasking kernel. The usrRoot routine initializes the memory pools, enables the HW watchdog, sets the system clock rate, connects the clock ISR, connects MCT SW INT ISRs, announces the task-create/task-switching hook routines (to setup GDTR/IDTR/Debug registers at task create/task switching), flashes the Red LED, create the MSG-queues for all possible tasks (four MCP tasks and sixty-two MCT tasks) on the MCP and installs the Ethernet card driver. Depending on a parameter (in the NVM1), one of the following will take place:

First, in a Bootp solution, usrRoot routine generates the bootload-task, that uses the bootp to retrieve the boot parameters and ftp the load image from the Bootp-server to RAM. After the image is loaded, the bootload-task is deleted and the just loaded code (MCP Manager code, routine MCPStart) is executed (see below).

Second, in a boot from flash solution, usrRoot checks to see if a routine MCPStart is on flash. If yes, userRoot loads MCPStart from EPROM to RAM and executes it, otherwise it falls back to Bootp.

The routine MCPStart generates the following tasks: software watchdog 54, messaging task 52, MCT code loading and start up task 56, the high priority MCP Maintenance task, the low priority MCP maintenance task, and the background testing task. SW watchdog task 54 is generated by the MCPStart routine. Its entry point is a routine called McpSwWD. It allocates and initializes (erases) the WatchDog table for all possible tasks, except the SW watchdog itself (i.e., Messaging, MCT Code loading and Startup, MCP Maintenance and n*Media Control tasks, n=62—this value may change, depending on the CPU performance—). After the WatchDog table initialization, the SW Watchdog Task 54 suspends itself (and will be awaken every 100 ms, “taskDelay”).

Messaging task 52 is generated by the MCPStart routine. Its entry point is the routine called McpMsgSt. It allocates and initializes (erases) the MCT Task Id⇄MBU/MCH conversion table and the Input/Output queues, programs the Ethernet card and starts the communication to NSP 22 (i.e. sends SYN).

MCT Loading & Startup Task 56 is generated by the MCPStart routine. Its entry point is the routine McpCode. It initializes (erases) an 8 MB RAM area for storage of the MCT code and a list of the MCT tasks (n entries, n=62). The MCT Loading & Startup Task 56 is then ready to receive code-loading sequence from NSP 22.

MCT Maintenance Tasks 58 are generated by the MCPStart routine through the high priority maintenance task using the entry point routine McpMtc. It allocates, initializes (erases) its memory, sends the message MCPRESET Response to NSP 22 (on both LAN sides), generates the low priority and background test tasks, starts a periodic timer 100 ms (to wake it up) and suspends itself with a call to msgQReceive routine.

The MCT tasks can be started only after the MCT code has been loaded to RAM (from NSP 22). After the MCT code loading, the MCT-Code-loading-and-startup task, based on the GDT included in the MCT-code creates GDT0 . . . GDTn−1. The code selectors of each GDT remain the same but the data selectors are adjusted to point to the associated data area of each MCT task. The stack selector is also adjusted to point to the physical address of the stack area assigned the MCT task.

The MCT-Code loading-and-startup task also calculates the total MCT-memory size (MCT-code excluded) and allocates/initializes (erases) n data areas for n MCT tasks.

The MCT-Code loading-and-startup Task calculates the stack size of the MCT task and the addresses of n stack areas of n MCT tasks. Note that the stack areas physically reside in the MCT memory areas.

The MCT-Code loading-and-startup task converts the address of the MCT-entry point “conditional code loading” to the VxWorks format.

The MCT-Code loading-and-startup task 56 creates n*MCT tasks (n=62) with the stack area, stack size and MCT-entry point in VxWorks format. The number of tasks is determined by the number of tasks for which the last code loading sequence was completed (number of tasks in the broadcast or single code-loading sequence).

MCT-Code loading-and-startup task activates the MCT tasks, which were created in the previous step. The activated tasks are now ready for receiving of the semi-permanent data from NSP 22.

MCP Recovery & Configuration has the following characteristics for the initial Start 2F. The initial condition is when MCP 28 is up with at least one ACT MCT Task in NSP 22 database. At the beginning of ISTART2F NSP 22 sends the MCPTEST command (to MCP Maintenance Task 58) and the MCP respond with MCPTESTR. NSP 22 then sends command MCPRST (Data: FULL reset), that causes the board to reboot. After reboot, the Software Watchdog Task 54, Messaging Task 52, MCP Loading and Start Up Task 56 and Maintenance Task 58 are generated and the MCPRSTR message is sent to NSP 22. After the command MCPLAN is sent from NSP 22 to MCP 28: Messaging Task 52, the following hand shaking sequence between NSP/ICC and the MCP Messaging/FW Boot tasks will take place: Collective Command (CCM):CHON/CHAR(load info=load program, LTG info:conditional loading)/CCM:CHAC/CHAS/CCM:RCVR (Data: SRL22 with RAM formatting)/CCM:CHON/CHAR (load info=load program, state=conditional loading).

Afterwards NSP 22 sends all MCT Code segments to the FW Boot Task, which stores them in the MCT code area that was allocated during MCP initialization after code loading, the MCT Loading & Startup task stores the MCH channel statuses and the indication of “Send TERE=YES”, TERE data to the interface areas (see 4.4.1.1) for all 62 MCT tasks. These data are the input for the MCT entry point MCT_Init routine. MCT Loading & Startup task also initializes and activates the MCT tasks that are in the collective command list. The activated MCT Tasks send TERE messages to NSP 22 and become active after the receiving semi permanent data and LTAC sequence.

MCP Recovery & Configuration has the following characteristics for the Initial Start 2R. The Initial condition is when the MCP is up with at least one ACT MCT Task in NSP 22 database. At the beginning of ISTART2R NSP 22 sends the MCPTEST command and the MCP responds with MCPTESTR. NSP 22 then sends command MCPRST (Data: Soft reset), that causes the SW Watchdog task to delete all MCT-Tasks, if any. Then the acknowledgment MCPRSTR is sent to NSP 22, which, in turn, sends command MCPLAN to the Messaging task 52 of MCP 28. Afterwards, the following hand shaking sequence between NSP/ICC and the MCP Messaging/FW Boot tasks will take place: Collective Command (CCM):CHON/ CHAR(data=same as ISTART2F case)/CCM:CHAC/CHAS/CM:RCVR (data:SRL22 w/o RAM formatting)/CCM:CHON/CHAR (data=same as ISTART2F case)

From this point on, the bring up is the same as in the ISTART2F case, except the MCT-code checksum is verified and is loaded only if the checksum test fails (but the MCT SW Boot code is always loaded).

MCP Recovery & Configuration has the following characteristics for the Initial Start 1, Initial Start 2. The initial condition is when the MCP is up with at least one ACT MCT Task in NSP 22 database. At the beginning of ISTART1 or ISTART2, NSP 22 sends the MCPTEST command and MCP 28 responds with MCPTESTR. NSP 22 then sends command MCPRST (Data: INIT). This command resets only the messaging task memory but the MCT Tasks are not deleted. MCP 28 then sends the acknowledgment MCTRSTR to NSP 22, which, in turn, sends command MCPLAN to the MCP:Messaging task. Afterwards, the following hand shaking sequence between NSP/ICC and the MCT Tasks will take place:

Collective Command (CCM): CHON/CHAR (info=no program loading, state=init)/CCM:CHAC/CHAS/CM:RCVR (data: SRL21)/PRAC/CM:CHAC/CHAS.

The MCT Tasks whose OST is ACT in NSP 22 database will receive LTAC commands and are configured into service. The MCT tasks, which were in service before ISTART1/ISTART2 but now have both message channels off, will be suspended by the Messaging task For a MCP Configuration that has a Single MCP Configuration with loading (CONF MCP, RESET=YES), the Initial condition is when MCP is MBL or UNA. Upon receiving of MML command CONF MCP to ACT with RESET=YES, NSP 22 sends the MCPTEST command and the MCP responds with MCPTESTR. NSP 22 then sends command MCPRST with Data=Full Reset to the MCP Maintenance task, result in a platform reboot and initialization. At the end of the initialization, the response MCPRSTR is sent to NSP 22. NSP 22 sends command MCPLAN to the MCP, selects the first “to be configured” MCT and tries to bring it up.

The first MCT task bring-up begins with the code loading into the MCP. The MCT code is downloaded with the following sequence: CHON/CHAR (data: same as in ISTART2Fcase)/CHAC/CHAS/RCVR(PRL22 with RAM formatting)/CHON/CHAR(data:same as above)/CHAC/CHAS/CLAC/LODAP/PAREN/code loading commands/CHECK/TERE.

The received code is stored in one common shared RAM area, as done in ISTART2F case. After the code is completely loaded, the MCT Loading & Startup task builds the GDT and allocates data areas for the MCT task that is being configured and initializes them. Then it activates the (being configured) MCT Task, which sets up its own environment (such as set up the register DS, ES, SS, SP . . . . ), initializes its semi-permanent and transient memory, sends the Test Result message to NSP 22 (only on the ACT LAN side). Then, after the sequence CHAC/CHAS/CLAC, NSP 22 continues to bring up the MCT task by sending the semi permanent data to MCP 28. The MCP Messaging Tasks passes the semi-permanent data to the MCT task, which finally becomes active after receiving a sequence of LTACs commands.

After the first MCT task is brought up, NSP 22 will sequentially bring up the remaining “to be configured” MCT tasks. The bring up starts with the hand shaking between the MCT Startup Task and NSP 22: CHON/CHAR (Data: Load Information=load program, state=Conditional loading)/CHAC/CHAS/RCVR(PRL22 w/o RAM formatting)/CHON/CHAC/CHAS/CLAC/LODAP/PAREN/code loading commands/CHECK/TERE.

After the hand shaking sequence, NSP 22 starts loading code to the MCP. With the exception of the MCT's software boot code, all other code segments are loaded only if the checksum examination fails. Then the GDT and data areas are allocated for the current MCT Task, as was done for the first task. This task is then activated and is configured into service after the data loading as described in the section above.

With a single MCP Configuration without loading (CONF MCP, RESET=NO), the Initial Condition is the MCP is MBL or UNA. Upon receiving of MML command CONF MCP to ACT with RESET=NO, NSP 22 sends the MCPTEST command and the MCP responds with MCPTESTR. NSP 22 then sends command MCPRST with data=Init (to maintenance task 56 of MCP 28). This command causes the Messaging task's database to be reset and the message MCPRSTR to be sent to NSP 22. Next, NSP 22 sends command MCPLAN to the MCP and then sequentially brings all MCT tasks with the Operation Status (OST) ACT in its database and brings it up with the sequence: CHON/CHAR (with data: same as Initial_Start_{—}1)/CHAC/CHAS/CLAC/RCVR (Data=FA:Level_{—}21)/PRAC/LTAC/LTAS.

In a Single MCT configuration, the command CONFLTGCTL is accepted by NSP 22. However, the parameter (LOAD=YES/NO) is no longer allowed. Depending on the loading flag in NSP 22 data base, one of the followings can occur:

In the MCT configuration with code loading, the initial condition is when MCP is active with at least one MBL/UNA MCT task in its database. The MML command CONFLTGCTL is entered to configure a MCT from MBL to ACT. The loading flag in NSP 22 data base is for some reason set (this flag should never set but for some reason, due to a SW error, it could remain set) The following sequence will take place: CHON/CHAR (with data: load info:load/no load, Init/Load—depending on the MCT state—)/CHAC/CHAS/CLAC/RCVR (Data=FA:PRL22)/CHON/CHAR/CHAC/CHAS/CLAC/LODAP/PAREN/code loading commands/CHECK/TERE

Upon receiving the RCVR (FA:PRL22)1 the MCP code-loading-and-Startup task deleted the configured MCT task. The code loaded from NSP 22 is accepted only if the MCT code has never loaded before or the MCT code is identical with the stored MCT code. Otherwise, the platform will re-boot. If the code loading is successful, the MCT task will be generated.

For single MCT configuration without code loading, the initial condition is when MCP is active with at least one MBL/UNA MCT task in its database. The MML command CONFLTGCTL is entered to configure a MCT from MBL to ACT. The loading flag in NSP 22 database is not set. The following sequence will take place: CHON/CHAR (with data: load info:load/no load, Init/Load—depending on the MCT state—)/CHAC/CHAS/CLAC/RCVR (Data=FA:PRL21) . . . .

In a normal case, i.e., the MCT code is already loaded, the MCT task is activated and will be brought up. If the MCT code is not yet loaded, the CHAR data will contain “forced loading.” If the MCT was active at some time prior to the configuration to MBL, and is now being re-activated, then the MCT will respond to the CP indicating that it can be activated without code/data loading. Alternately, if the MCT was never activated before, then the MCT startup task will respond indicating that conditional code loading and data loading are necessary.

Each MCT task has its own GDT, IDT and breakpoints. When switching tasks, the VxWorks OS has to save/ restore the GDTR, IDTR and Debug Registers of the old/new task. In addition, some interface variables need to be updated, such as increment/deletion of counters, that can be used by the MCT task to detect “Program runtime too long”, or to make a determination whether or not it can prematurely terminate its round-robin time slice. To achieve this, a routine (MCPCtxSw) is provided to the VxWorks OS (taskSwitchHookAdd) at platform initialization. The routine MCPCtxSw will be invoked at every task switch, which will ensure that each task is running with its own GDT, IDT and breakpoints.

The tasks on the MCP platform are running under a mixture of preemptive priority and round-robin scheduling algorithm. The MCP tasks (MCT tasks excluded) below are listed from high priority to low priority order:

Software watchdog: performs its function and then sleeps for 100 ms with taskDelay

Messaging task: wake up only if there are message(s) in one of its message queues

MCT Code loading and Start up task: wake up only if there are message(s) in its input queue

MCP High priority Maintenance task: wake up only if there are message in its input queue. Since this task also performs periodic tasks (such as check the memory leaking (i.e., hung resources) or control the LEDs), it starts a 100 ms timer to wake itself up.

all MCT tasks have the same priority, which is lower than the priority of any of the tasks of the group above. The MCT tasks run with round-robin scheduling. Each task gets a time slice of 1 ms. A MCT task can prematurely finish its time slice if its has nothing to do, i.e., its task queue is empty. In this case, an MCT audit program is invoked, that runs a few steps and then suspends the MCT task until a message is queued in its queue.

MCP low priority Maintenance task runs with priority just lower than the MCTs (e.g., patching, upgrade & burn flash in the background).

MCP Background Testing Task runs with the lowest priority (audits, routine test etc.) Standard VxWorks interrupt handlers are used for most exceptions and for all external interrupt sources. A new MCP specific exception handler replaces the Stack Fault exception handler. In addition, the platform timer interrupt is configured specifically for MCP/MCT operation.

The periodicity of a platform timer is set to 1 ms during VxWorks startup. The usrClock routine is called on each interrupt. It informs the VxWorks OS that the timer expired and updates the MCP common clock (every 4 ms) that are used (read only) by the MCT timer management tasks.

Looking at the stack Fault Exception, the default VxWorks stack fault exception does not execute a task switch, and so is incapable or recovering from a stack fault. Instead, a new exception handler is used to allow recovery from stack faults in the MCTs. This exception handler is allocated its own Task State Segment and stack. When a stack fault occurs, the exception handler first determines whether the fault occurred within a MCT or in the general VxWorks context (kernel or other MCP tasks). If the fault occurred within the general VxWorks context, then the platform is restarted since this represents a non-recoverable error. However, if the exception occurred within a MCT, then the task state of the MCT is modified so that it resumes execution at the existing stack fault recovery software within the MCT. The exception handler also rebuilds the MCT stack so that it can resume operation correctly. Note that all interrupts on the VxWorks platform are disabled for the duration of the stack fault exception handler.

The ability of a MCT to recover from processor exceptions are retained on the MCP. In order to accomplish this, MCP software receives exception notifications from the operating system and actively repairs and restores these failed MCTs. This is done by the use of Signal Handlers.

Each MCT registers a signal handler for all the standard processor exceptions. When an exception occurs, the failed MCT is suspended by the operating system and the corresponding signal handler is invoked. It is not possible for this signal handler to repair the failed MCT due to OS limitations, so this signal handler notifies a signal handler running under the MCT Startup task.

The MCT Startup Signal handler uses data passed within the signal to restart the failed MCT. The execution point of the MCT is modified to begin execution at the MCT recovery code that corresponds to the exception. In addition, operands are added to the stack to provide the same interface as is expected by MCT software. Finally, the failed MCT is restarted using the taskResume( ) facility of the operating system. Note that this logic is also applied for “debug” exceptions, with the modification that the code execution point is the MCT debug exception handler instead of MCT recovery code.

The MCTs need to interface to certain VxWorks services. Since the MCTs operate in 16-bit mode and are separately linked, this interface cannot be implemented via a direct “call”. Instead, an indirect interface is used through “Call Gates”.

On activation of the MCTs, a reserved descriptor entry in the MCT GDT is configured to represent a call gate. When the MCT invokes this call gate, it will be redirected to execute a procedure within the VxWorks image, whose address has been populated in the call gate descriptor. A translation from 16-bit to 32-bit code segments will also take place. Note that although the call gate performs 16-bit to 32-bit translation of the code segment, the stack and other data segment registers remain as they were when executing on the MCT. Consequently, the procedure invoked by the call-gate first saves the existing environment and then set-up a new VxWorks compatible environment. Further VxWorks services can then be invoked.

The call gate interface is used by the MCT to invoke the services to receive one or more messages from the MCT message queue and/or to send a message to another MCP task or out on the LAN. Parameters for the call gate interface are passed using shared memory between the MCT making the call and the call gate software. This memory is part of the MCT image, but can be referenced and modified from the VxWorks address space.

The required call gate descriptor is built by the MCT Startup task. The actual call gate function is provided as a separate MCP platform module.

Each MCT is notified when a fixed interval of time has expired. The Timer Function detects this time period and provides the necessary interface to the MCTs. The following functions are implemented: Interface with the VxWorks operating system for timer interrupt notification; and when a predefined number of timer interrupts occur, increment global time counter (MCP_CLOCK) to reflect passage of time.

MCP_CLOCK is located within the MCT address space, at a pre-defined label. This data is shared across all MCTs, so that it is not necessary to update each task's data individually.

The value in MCP_CLOCK is used by the MCTs to calculate elapsed time. Refer to the “MCT Software” section for details on this mechanism.

With this mechanism, the minimum granularity of MCP_CLOCK is dependent on the granularity of the VxWorks timer interrupt. However, MCT timers will still be limited to 100 ms granularity due to the latency of the MCT round-robin scheduling scheme. Due to scheduling considerations, the periodic VxWorks clock will be set to fire every 1 ms. In order to preserve the existing MCT clock intervals, MCP_CLOCK will be incremented every 4 ms, by the VxWorks clock interrupt handler.

A periodic notification is sent to all MCTs every 100 ms. This notification is used to “wake-up” MCTs that have no messages pending in their message queues, and are blocked. The notification is necessary so that the MCTs can updated their timers and process any internal jobs.

The global MCP_CLOCK variable is defined at a fixed label within the MCT address space. This is necessary so that the MCTs can refer to this label within their linked load. MCT_CLOCK is defined as “Read Only” within MCT address space.

When activating a MCT, a layer is necessary between the startup task and the actual MCT software. This layer is implemented in C and allows registration of the MCT with the operating system for functions such as Signal Handling or Message Queues. It also allows for a standard ‘C’ entry-point into the MCT which simplifies MCT startup. At the end of the MCT startup layer, the actual MCT code is invoked via an inter-segment jump.

As with any processing platform, the MCP may encounter “overload” conditions during its normal operation. MCP Overload can be classified as a memory (or other resource) overload, a message input/output overload, an MCP Isolation or a CPU overload. Each type of overload is detected and reported to NSP 22 via the new MCP_STAF message. This message includes data such as the overload type, overload level, and time of overload entry. In addition, steps are taken to attempt to reduce the overload condition, by reducing the traffic rate on the MCP. When overload ends, NSP 22 is notified again using a MCP_STAF. These functions are implemented in the high-priority MCP Maintenance Task and are described below.

Maintenance task 58 is responsible for general platform maintenance of the MCP. This includes fault detection, configuration, recovery and testing. Maintenance task 58 is split into two sub-tasks—a low-priority task and a high-priority task. The overload function is implemented in the high-priority task, since it is a time critical function.

In order to detect MCP Overload, Maintenance Task 58 are periodically monitored all resources that affect each type of overload.

For Memory Overload detection, Maintenance Task 58 performs a periodic check of the remaining available memory in the dynamic memory allocation pool. When this memory reaches a certain threshold (25% available for example), then it can be assumed that the MCP is running out of memory due to system demands and MCP overload is initiated.

For Message Output Overload, Maintenance Task 58 performs a periodic check of the queue depths of the Messaging Task 52 and the Ethernet driver interface. If these queues fill up to a certain threshold (80% for example), then it can be assumed that the MCP is not able to handle the current output message rate and MCP overload is initiated.

For Message Input Overload, Maintenance Task 58 performs a periodic check of the queue depths of the input queues of each MCT on the MCP. If the average queue depth reaches a certain threshold (80% for example), then it can be assumed that the MCP is cannot cope with the current input message rate, and MCP overload is initiated.

For MCP Isolation, this type of overload is detected by the Messaging Task 52, when both LAN interfaces are determined to be faulty. When this occurs, Maintenance Task 58 is notified, so that it can set the MCP overload level appropriately.

For CPU Overload, if the MCP CPU is overloaded, then each MCT will receive insufficient run-time. This will be detected by the MCTs through the “Task Queue Overload” mechanism, and will be reported to NSP 22. No actions are necessary in Maintenance Task 58 for this type of overload detection.

Once MCP overload has been detected, Maintenance Task 58 sends a MCP_STAF to NSP 22 to indicate the overload condition, and type of overload. Maintenance task 58 then sets a global “MCP Overload” indicator, which can be read by all the MCTs. This indicator will cause the MCTs to enter a local overload condition. Under these conditions, the rate of new MCT traffic will be reduced, which also reduces the current MCP overload level. Only 1 overload level is seen to be necessary at this time.

After overload has been detected, Maintenance Task 58 continues to monitor the overload condition in order to determine when normal operation can be resumed. Normal operation is only resumed when the depleted resource has returned to normal levels. This threshold is set so that a level of “hysteresis” is built-in to the overload mechanism—i.e., the threshold for normal operation is significantly lower than the threshold for overload detection. This will ensure that the MCP does not oscillate constantly between overload and non-overload states.

In some situations, it is possible for software errors to lead to spurious overload conditions. For example, a memory leak could lead to “Memory Overload”. In order to avoid a permanent degradation of service in such situations, Maintenance Task 56 monitors the duration of a given type of overload. If this duration exceeds a certain limit (30 minutes for example), then a platform reset is executed. This will allow the redundant MCP to take over and provide a better level of service. A global data item is necessary to indicate MCP overload. This data is readable from each MCT. The MCP provides a replacement for the 4 ms timer interrupt that is used by MCT software.

The MCP provides functionality for sending and receiving the following message types over the Ethernet LAN interface:

1. Commands and Messages between MCTs and the CP

2. Reports between MCTs

3. Messages between the Packet Manager and MCTs

4. Incoming and outgoing signaling requests to the signaling gateway

The Messaging functionality of the MCP is divided into 2 parts: Platform Functions and LAN Functions. Platform functions provide interfaces to all the MCP tasks, including the call control tasks, for the purpose of message sending and receiving. They also handle message channel maintenance and distribution of incoming messages, including broadcast or collective distributions.

LAN functions provide the interface between the Platform Functions and the two Ethernet cards of the MCP. They handle translation between EWSD MBU/MCH destinations and Ethernet MAC addresses. They also handle maintenance of the LAN interfaces, and make routing decisions regarding the LAN side to be used for certain classes of outgoing messages.

Platform functions provide interfaces to all the MCP tasks, including the Media Control Tasks, for the purpose of message sending, receiving and distribution. The Messaging Task also provides the MCP with its message channel maintenance function.

The MCP Messaging Task provides tasks running on the MCP with the ability to transmit messages to other platforms in the network. Interfaces are provided through “Call Gates” in the MCT task's software at the point where message transmission is required. The Messaging Task defines procedures called by through the call gates to read message data from the task's output buffer. The Messaging Task then writes the message to an output queue for transmission across the LAN (see LAN functions for further details).

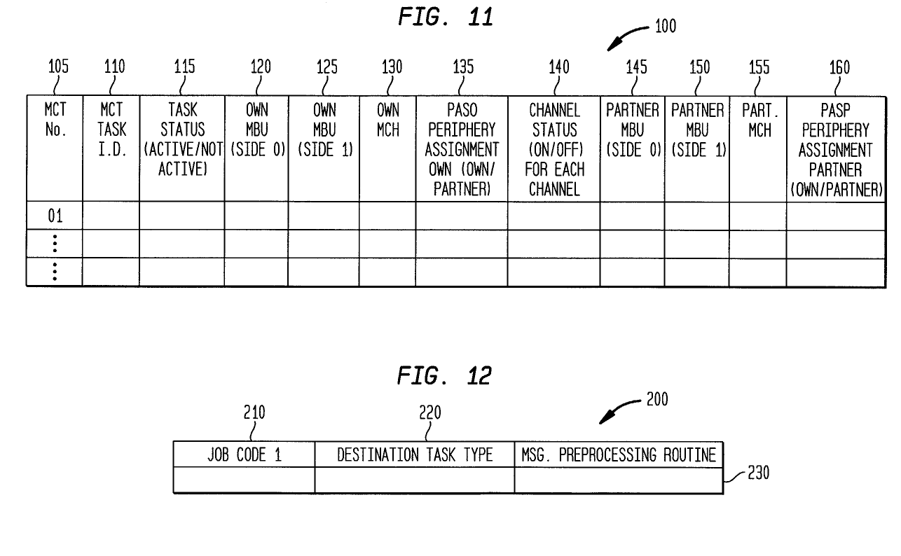

Referring to FIGS. 11 and 12, the MCP's Messaging Task receives incoming messages from the LAN, determines their destination, and writes the data to the destination task's receive buffer and/or processes the command if appropriate. The Messaging Task maintains two tables 100, 200 used for routing messages called a MCT Communication Table 100 and a Command Distribution Table 200.

MCT Communications Table 100 has twelve columns. The columns include an MCT number 105, an MCT task ID 110, an own MBU (side 0) 120, Own MBU (Side 1) 125, a own MCH 130, a Peripheral Assignment Own (Own/partner) 135, a channel status (on/off) for each channel 140, a partner MBU (Side 0) 145, partner MBU (Side 1) 155, Part MCH 155 and a periphery assignment partner (own/partner) 160.

Command Distribution Table 200 includes three columns. A first column 210 records Job Code 1, a second column records destination task type 220 and a third column record 210 the “message preprocessing routine” 210 “Msg. Preprocessing Routine” column 230 tells Messaging Task 52 that this command contains information used by the Messaging Task. For instance, in the case of C:LTAC, Messaging Task 52 will look into the command and update its MCT Communication Table 100 with the Periphery Assignment 135 information contained in the command.

The MCT messages are routed based on MBU/MCH numbers and Task Status (active/not active) 115. Messaging Task 52 uses MCT Communication Table 100 to determine which MCT the incoming message is destined for (via MBU/MCH) and if it's available to receive the message (by Task Status 115). After Messaging Task 52 determines the incoming message is destined for a MCT and that task is active, the incoming data is stored in a receive buffer reserved only for that task. Messaging Task 52 increments a ‘write’ counter for each message written to the MCT's buffer. This count tells the MCT task that it has one or more messages waiting and should execute a read of the buffer.

Certain MCT messages do not have a MBU/MCH associated with them. Examples are MBCHON and all collective or broadcast commands. For such commands, a special header field is examined to determine the relative MCT number(s) for which the message is destined. The MCT number is then used to derive the specific MCT task that should receive the message.

The MCP tasks themselves also receive platform Task Messages (e.g., SW Watchdog, Boot, Startup, etc.) over the LAN, directly from NSP 22. These messages are distinguished by the Messaging Task based on the target MBU/MCH. Each MCP is allocated a fixed address that corresponds to the first MCT position on the MCP (0-1, 1-1, 2-1 etc.). Such messages are routed to the appropriate platform task, based on the received JC1/JC2 combination.

In certain cases, namely Maintenance and Recovery, commands currently handled by classic MCT software are routed to designated platform tasks running on the board. Before a message is distributed via MBU/MCH lookup, Messaging Task 52 examines the JC1 of the message. If the incoming command is of a ‘special’ type (RCVR, LOAD, etc.) and destined for a platform-task, the message is copied to that task's receive buffer for processing.

The following is a Message-Distribution Summary:

1. Reads message from its dedicated input queue

2. Determines if message is an incoming message (from the LAN) and need to be distributed.

3. If message is an incoming message, determines message type, based on target MBU/MCH—either MCP message or MCT message.

4. If MCP message, use Job Code 1/Job Code 2 (JC1/JC2) to route message to correct platform task. JC1/JC2 of MCH maintenance messages are directly processed by the messaging task. END.

5. For MCT messages, use message header information to determine relative MCT or MCTs for which message is intended.

6. Get associated ‘Destination Task ID’ from Command Distribution Table using relative MCT(s) index(es).

7. If the target MCT is not created or not active, route message to MCT Startup Task. END

8. If MCT is created and active, check JC1/JC2 to see if message should be redirected to platform task anyway (Code loading messages etc.). If redirection required, send message to appropriate task. END.

9. If target MCT created and active, check if preprocessing required i.e., Msg. Preprocessing Routine not null.

10. If preprocessing required, calls routine specified. After preprocessing finished, or if preprocessing not required, resumes with next step.

11. Copy message to target MCT message queue. END Messaging Task 52 contains logic to intercept and redirect outgoing reports if they are destined for an MCT running on its platform. Messaging Task 52 examines each outgoing message's destination MBU/MCH number for a corresponding task entry in its ‘MCT Communication Table’ 200. If it finds a match, and that task's periphery assignment is set to own, then the report is copied to that MCT task's input buffer. Alternately, if the destination MBU/MCH is found in a task's partner MBU/MCH entry, and the corresponding partner-periphery assignment is set to partner, then the report is also redirected and 1s copied to that task's input buffer.

In order to distribute incoming commands and messages to the MCT, Messaging Task 52 maintains a table associating each Media Control Task ID with a unique MBU/MCH combination along with its associated channel and task status information. When Messaging Task 52 receives a message and its JC1 indicates it is of the channel maintenance type, the corresponding task entry in the table is updated accordingly. If the task table does not contain an entry with the received MBU/MCH combination, the message is forwarded to the MCT Startup task for further processing.

When the MCP's Messaging Task 52 detects an incoming MBCHON command, it reads the channel bitmap contained in the message and updates any corresponding entries in the MCT Communication Table with an ‘ON’ indication. The command is then forwarded to the Startup task for further processing.

CHOFF: When Messaging Task 52 detects an incoming Channel-Off command, the corresponding channel status entry for that channel is updated (turned off). If both channels for a given MCT are turned off, then that task is suspended until the C:CHON is received. Further commands received for a task on a message channel which has been turned off are discarded. Send requests from a task for a channel which has been turned off are also discarded.

ADINF: Before forwarding the Address Information Command to the MCT, the Messaging Task extracts address related information from the command and updates its MCT Communication Table 100.

The Messaging Task 52 reads Periphery Assignment information from the LTG Active command (LTAC), updates the corresponding element of its table, and forwards the command to the MCT.

The MCP uses dual Ethernet cards to interface with the LAN. The Messaging Task provides an interface to the device drivers of the two LAN cards. The LAN device drivers are provided with the VxWorks operating system. The drivers directly interface with the VxWorks Network daemon when incoming messages are received. Outgoing messages are directly sent using driver interfaces.

Since the softswitch does not use a TCP/IP stack for internal communication, it is necessary to trap incoming Ethernet messages before they are delivered to the protocol stack. This is done using the “Etherhook” interfaces provided by VxWorks. These interfaces will provide the raw incoming packets to the Messaging Task.

Incoming frames from other softswitch platforms are assumed to be using the standard Ethernet header (not IEEE 802.3). Messaging Task 52 distinguishes between Ethernet and 802.3 type frames using the 2 byte “Type” field. In addition, Messaging Task 52 also determines whether the packet is using internal softswitch Ethernet protocol or is a real TCP/IP packet. This can also be done using the “Type” field of the packet. A special value will be used for packets that encapsulate a softswitch internal message, in order to distinguish them from IP packets or other packets on the LAN. Packets using the internal protocol are queued to the Messaging Task input queues. Other packets are returned unchanged for processing by the TCP/IP stack. For security reasons, the Messaging Task verifies the source MAC address before accepting packets that use the internal softswitch protocol. All such packets have source MAC addresses within the internal LAN.

When sending outgoing messages, the Messaging Task uses driver specific interfaces to output one or more messages. Outgoing messages are always sent with the standard Ethernet frame header, and the softswitch protocol indicator in the “Type” field. Care is taken to ensure that the driver is not overloaded with message sending requests. The interface with the driver is examined to determine the maximum send requests that can be processed at one time. Message send requests that exceed this threshold is queued to a retransmit queue by the Messaging Task for sending at a later time. Messages on the retransmit queue are sent first on any subsequent attempts to output messages to the driver. In addition, a periodic 100 ms timer is used to trigger retransmit of messages on this queue.

In summary, the Ethernet interface consists of an “Etherhook” interface for incoming packets, with filtering of softswitch specific messages; a Message Send interface to be used by the Platform portion of the Messaging Task where the parameters include the destination MBU/MCH address and desired LAN side; a Message Queuing function to be used if the target driver is busy; and a periodic message re-send function to attempt retransmission of queued messages.

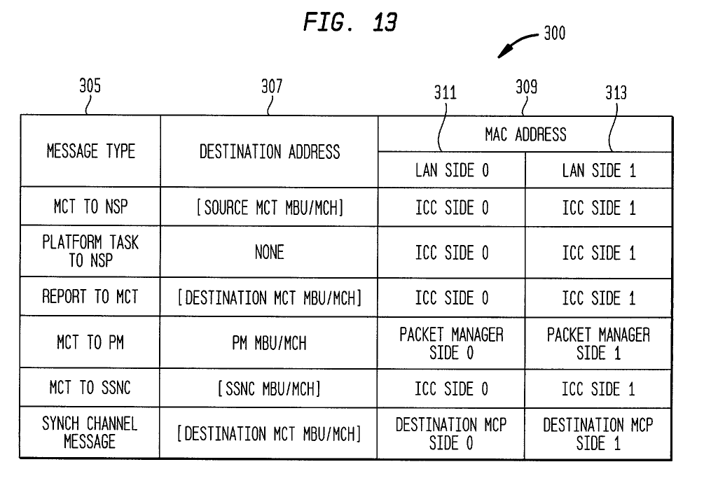

Referring to FIG. 13, Messaging Task 52 performs address a conversion to convert internal Message Buffer Unit (MBU)/ Message Channel (MCH) addresses into external Ethernet MAC addresses. These conversions are only necessary when sending messages out over the Ethernet LAN. For incoming messages, the MAC address need only be stripped off.

A table 300 shows the conversions that are necessary. Table 300 has three main columns. A first column 305 stores a message type, the second column stores a destination address, and a third column 309 stores a set of MAC addresses as two columns, a LAN Side 0 column 311 and a LAN side 1 column 313.

From table 300, it can be seen that for most outgoing messages, the target MAC address is fixed to ICC 24, Packet Manager or Integrated Signaling Gateway (ISG), regardless of the source MCT MBU/MCH.

Synch Channel messages require additional address conversion, because they are delivered directly to the target MCP. The Destination MBU/MCH of the target MCT are converted into the MAC address of MCP 28 that hosts this task. This conversion is implemented by converting the target MBU/MCH into a MCT number, consisting of TSG & LTG. This can then be converted into a host MCP number, using the standard mapping of TSG/LTG to MCP 28. In future releases, the address conversion as described for Synch Channel messages may also be used for routing of reports between MCTs on different MCPs.

The entire address conversion function as described above are implemented in Messaging Task 52.

MCP 28 uses two separate Ethernet interfaces for communication. Each interface is connected to its own LAN and ICC side. Incoming messages can arrive over either LAN interface, and are processed regardless of which interface the message was received on. Outgoing messages are selectively transmitted on a specific LAN side. The correct LAN side is selected by the Messaging Task during the transmission of the message. The selection is based on rules.

One rule is that messages from a MCT to NSP 22 or other MCTs are sent on the LAN side corresponding to the source task's “Active” message channel. This information is provided to the LAN interface function by the Platform interface.

Another rule is that messages to NSP 22 from Platform Tasks can be sent on either LAN interface. Since these messages could be sent under different statuses of MCP 28 (initialization, failure etc.), the Messaging Task allows the platform tasks to specify a target LAN side (Side 0, Side 1, Both sides etc.).

A third rule is that messages to the Packet Manager are sent on either LAN side as specified in the “MCP LAN” command received from NSP 22. This information is provided to the Messaging Task by NSP 22 on startup, and following any changes in connectivity with either the PM. The MCP LAN command indicates whether LAN side 0, LAN side 1 or both LAN sides could be used for PM communication.

A fourth rule is that synch channel messages can be sent on either LAN interface. The Messaging task attempts to use the LAN side corresponding to the source MCTs “Active” message channel. If this path to the partner MCP is faulty, then the other LAN side are used instead (the Messaging task maintains a status for the path to the partner MCP over each LAN side—see “Fault Detection”).

There is a potential for lost messages, since the Ethernet is used as the transport protocol within the softswitch. This is because no low-level “layer-2” acknowledgement mechanism is provided. This is not a problem for messaging between the media control tasks and other platforms, because all such messaging is already supervised at the application layer. However, it is considered when implementing new message interfaces to MCP software. Such interfaces implement their own supervision mechanisms.

As described earlier, it is possible for the Ethernet driver to be overloaded with message send requests. If this occurs and retransmission is not possible after 200 ms, then the messages are discarded and an error counter incremented to indicate lost messages. If this is a permanent condition, then the ICC will detect loss of this LAN interface due to loss of the periodic FLAGS responses, and take appropriate actions.

When sending Synch Channel messages, it is possible for there to be no path between MCP 28 and its partner. In this situation, synch channel messages are discarded. An error counter are incremented to indicate lost messages. It may also be desirable to record the message data for debugging purposes.

Address conversion is performed based on the assumption that all units know all the MAC and MBU/MCH addresses within the system. If invalid addresses of one type or another are encountered, then the corresponding messages are discarded, and counters incremented to indicate lost messages. It may also be desirable to record the message data for debugging purposes.

In certain situations, the point-to-point communication path between the MCP and its partner MCP or the Packet Manager may be unavailable due to double-failures of LAN interfaces. Handling of this scenario is described under the “MCP Fault Detection” section.

Data structures are implemented to support these LAN functions. The structure include a message retransmit queue, an address translation table, a synch Channel address translation table, an error statistic counters for lost messages with specific counters for the various error types and for incoming and outgoing directions, and a storage for the LAN side to be used for PM communication.

MCP detects and reports failures of a single media control task, specifically due to infinite loop conditions, failures of any of the MCP manager tasks, hardware faults, detected by periodic routine testing, software Faults, detected by individual tasks, complete failure and restart of the platform, and Media Control Software corruption. Failures of the MCTs or other platform tasks are detected by the Software Watchdog Task. Hardware failures or corruption of MCT software are detected by Maintenance Task 58. MCP Reset is detected through message interfaces and supervision between MCP 28 and the ICC. Software faults can be detected by any of the MCP Manager tasks, but are reported via an interface in Maintenance Task 58.

In addition to the above platform specific failures, interfaces are also provided on MCP 28 for detection of faults on the LAN, and to verify the paths between NSP 22 and MCP, between MCP and partner MCP and between MCP and Packet Manager.

The following describes the implementation of the trouble detection, isolation and notification functions provided on MCP 28.

Software watchdog task 54 is responsible for supervising the MCTs and all other tasks on MCP 28. It is the central point of software failure detection on the call-control platform. In order to provide this function, the software watchdog task creates and maintains a data structure (Watchdog Table) with entries for each possible task, provides an interface to allow each task to update its Watchdog Table Entry every 100 ms, detects when a given task has failed to update its Watchdog Table Entry for a minimum of 200 ms, and triggers the hardware watchdog on MCP 28 to indicate that MCP software is still operational. The Software Watchdog function supervises Media control tasks, Messaging Task, MCT Loading & Startup Task, MCP Maintenance Task and MCP Upgrade Task.

During normal operation, the software watchdog task monitors its Watchdog Table to determine whether a given task has failed or been suspended by the operating system. The watchdog task uses operating system interfaces to determine when tasks block on resources, or go into “PENDING” states, so that they are not erroneously marked as failed.

When a failure of a task has been detected, the software watchdog task is responsible for restarting the failed task, and generating an appropriate failure indication to the CP. These actions are dependent on the type of task failure, and are described below.

If a media control task fails to update its watchdog table entry, then the task is assumed to be operating in an infinite loop. The task is terminated and re-started by the software watchdog task, via an interface to the MCP Loading & Startup task. This will cause the failed MCT to be terminated and a new incarnation started. The new media control task will begin execution at the point where semi-permanent data loading is expected to begin. This will have the effect of putting the MCT through a Level 2.1 recovery.

The indication of a task failure is passed on to MCT Loading & Startup task, which then restarts the MCT, with special input parameters. These parameters cause the MCT to generate a STAF (Standard Failure) message to NSP 22, with a fault indicator of “1.2 Recovery”. This will cause NSP 22 to initiate a switchover (if possible), and recover the call control task with data reload. A new recovery error code will be used to indicate that the software watchdog task detected the failure.

Software faults are also possible in any of the VxWorks platform tasks. If one of these tasks fails to update its watchdog table entry, then it is assumed that the task has been suspended by the VxWorks operating system. When this condition is detected, the software watchdog initiates a reset of the entire platform (less severe fault actions are possible, but they would leave the possibility of hung resources in the VxWorks operating system). NSP 22 is notified of this failure as part of the normal platform restart sequence (see later sub-section for Messaging Task fault detection), as well as via a MCP_STAF message.

Failure of the software watchdog task itself is detected by a hardware dependent watchdog function. The hardware watchdog resets every iteration of the Software Watchdog task. Failure to perform this function results in a reset of the entire platform. NSP 22 is notified of this failure as part of the normal platform restart sequence (see later sub-section for Messaging Task fault detection).

The Software Watchdog task provides a data structure—the Watchdog Table, that can be used to monitor all the MCP tasks. This structure is accessible by all software components, and is protected by semaphores to avoid read/write conflicts during access by the software watchdog tasks or any of the supervised tasks. The watchdog table includes a Task ID, a Watchdog Counter (incremented by tasks to indicate they are alive) and Block Flag (indicator that task is in a blocking mode and are not supervised).

Messaging Task 52 provides the interface to the Ethernet LAN for MCP 28. In the context of Fault Detection, this task provides a mechanism for notifying NSP 22 when the entire MCP is restarted, a mechanism for notifying NSP 22 when MCP 28 is faulty, and can no longer support call-control functions, an interface for supervision of Ethernet LAN from the ICC, and a mechanism for detecting mismatch conditions for LAN connectivity between MCP and partner MCP or MCP and Packet Manager.

MCP 28 may be restarted for any one of the following reasons: timeout of hardware watchdog, failure of platform task detected by software watchdog task, initial Startup of MCP 28 or NSP 22 requested restart on ISTART2F. MCP 28 does not keep any history across a restart. Consequently, NSP 22 is notified that the platform has performed a reset, so that appropriate fault actions can be taken. In order to accomplish this, a special message (“SYN”) is sent to both planes of the ICC when the Messaging Task is first started. The SYN provides notification to the ICC that a restart has occurred on a certain platform. On receipt of the SYN, the ICC will report message channel errors for any channels that may still be marked as ‘in use’.

NSP 22 is notified if hardware faults are detected on MCP 28, resulting in the inability to support call-control functions. This is implemented in Messaging Task 52 by providing an interface that allows other platform tasks to trigger sending of the “SYN” message. This interface will be used mainly by the MCP Maintenance Task.

ICC 24 supervises the Ethernet LAN. In order to provide quick detection of failures on the LAN, the ICC will send special “FLAGS” messages every 100 ms to all MCPs on the LAN. The Messaging Task on MCP 28 provides the following functions to complete the LAN supervision interface. First, Messaging Task receive the FLAGS message from ICC 24 and all other MCPs. Second, it generate a response to the FLAGS message from ICC 24, in order to notify the ICC that the corresponding LAN interface on the source MCP is working. Third, it processes data in the FLAGS message to determine connectivity to other MCPs over the same LAN side (the FLAGS message contains a bitmap with the current state of the MCP—ICC connections). This data is used to determine the path to be taken for synch channel messages to the partner MCP.

Fourth, the Messaging Task supervises FLAGS reception from ICC 24. Failure to receive FLAGS for a fixed period of time results in the LAN interface being declared as faulty, and the sending of all further messages on the redundant LAN side.

Messages sent from MCP 28 to the Packet manager or to the partner MCP are delivered “point-to-point”. Consequently, it is necessary for MCP 28 to be aware of the connection availability of the target platform on either of the two available LAN sides, and to select the appropriate LAN side for communication.

For MCP—PM connectivity, on initial startup of MCP 28, NSP 22 notifies MCP 28 of connectivity to the Packet Manager using the MCP_LAN command. This command provides the available LAN interfaces that can be used for communication with the packet manager. The MCP_LAN command is resent if faults cause a change in the PM connection availability. This information is used by MCP 28 to select the appropriate LAN side for MCP to PM messages.

In certain situations, faults may cause MCP 28 and PM 26 to have mismatched connections. MCP 28 may only be able to use LAN side 0 for transmission, but PM 26 may only be able to receive messages on LAN side 1. In such situations, MCP 28 reports a fault to NSP 22 via the MCPSTAF interface (for notification) and then fail the platform using the “SYN” interface.

For MCP—Partner MCP Connectivity during normal “duplex” operation, each MCP needs to communicate with its partner MCP for transmission of Synch Channel messages. These messages are also sent “point-to-point” and require the MCPs to be aware of the connection state of the target MCP. As described under “Ethernet Supervision” this information is obtained by monitoring the “FLAGS” messages from ICC 24.

In certain situations, faults may cause MCP 28 and partner MCP to have mismatched connections. MCP 28 may only be able to use LAN side 0 for transmission or reception while the partner MCP may only be able to use LAN side 1. Such a situation is analogous to the existing “Synch Channel Failure” state of real hardware MCTs. When this occurs, one of the MCPs fails so that a switchover of MCTs can occur. Since both MCPs should not fail, and cannot coordinate their failure due to lack of communication interfaces, the lower-number MCP assumes the role of the “failing MCP” and the high-number MCP remains in operation. Failure of the low-number MCP is reported to NSP 22 using the MCPSTAF interface (for notification) followed by the “SYN” interface to trigger MCP configuration.

If both LAN interfaces of an MCP are found to be faulty (no FLAGS received), then the Messaging task takes steps to prevent the loss of messages. This is done by interfacing with Maintenance Task 58 to trigger MCP overload. This will in-turn trigger overload conditions in the MCTs which will cause each MCT to discard unnecessary call-processing messages, but preserve critical messages in their own internal queues. When communication has been restored, Messaging Task 52 clears the overload condition to allow sending of the buffered messages.

Messaging Task 52 maintains data on connectivity with other MCPs over the two LAN interfaces. This data will be updated by the FLAGS message sequence, and is used in determining the LAN on which Synch Channel messages will be sent.

In order to support trouble isolation and notification, Maintenance Task 58 provides an interface to NSP 22 for recovery, configuration and test; an interface to NSP 22 for verification of MCP load version information; background hardware test functions; background verification of call-control software integrity; and software fault reporting.

Some functions of maintenance task 58 are background maintenance functions, which do not interfere with normal call-processing functions of the MCTs. Consequently, Maintenance Task 56 functions 50 are separated into three tasks: a high-priority maintenance task, a low-priority maintenance task and a background routine test task. The low-priority task performs non-time critical functions such as firmware upgrade or patching. The background test task performs routine testing and audit functions that execute at the lowest system priority. The high-priority task is reserved for processing time-critical functions such as MCP configuration and recovery.

MCP 28 provides an interface to NSP 22 for the purpose of executing different reset levels of the platform. This interface is used during System Recovery and MCP configuration, to ensure that MCP 28 reaches a known state prior to activation. The interface is implemented using new commands and messages (MCPRESET and MCPRESETR) between NSP 22 and Maintenance Task 58. The use of this interface is described in detail in the “MCP Recovery and Configuration Section”. Since this function is time-critical (responses is sent to NSP 22), this function is implemented in the high-priority maintenance task.

Maintenance Task 58 also provides an interface for testing the communication path from NSP 22 to MCP 28, and to verify that the MCP platform software is operating correctly. This interface is used during system recovery, MCP configuration into service and MCP testing. The interface consists of a new command (MCPTEST) which is sent by NSP 22 to Maintenance task 58 on the target MCP. Maintenance task 58 processes this command and responds with a new message (MCPTESTR) which indicates an MCP Fault Status (No Faults or Faults Detected), a MCP Fault Type (Hardware Fault, Software Fault, Overload) and an MCT Status. The MCP status has a Bbitmap representing sixty-two media control tasks, indicating whether each task is currently “active” or “inactive”. An “active” MCT is one that is being actively scheduled by VxWorks. An “inactive” MCT is one for which no instance has been created on MCP 28.

Maintenance Task 58 also provides an interface for load version verification. This information is included in the MCPTESTR response to NSP 22.

Although the MCP software operates on a commercial platform, certain hardware test functions are possible. Maintenance Task 58 performs these functions in the background, in an attempt to detect hardware errors. This function is limited to the verification of MCP memory where memory verification is done by executing iterative read/write/read operations on the entire MCP memory range.

If MCP hardware failures occur, Maintenance Task 58 notifies NSP 22 that it is unable to support any media control functions. Restart of MCP 28 in this situation is not desirable, because MCP 28 would lose information about its hardware failure, and would attempt to resume service if asked to do so by NSP 22.

When a hardware fault is detected, Maintenance Task 56 marks MCP 28 as faulty, and trigger sending of the “SYN” message to both planes of ICC 24, via Messaging Task 52. This will cause NSP 22 to fail MCP 28 and its associated media control tasks. A MCP_STAF message are also sent to NSP 22 to indicate a hardware fault. This message is for information purposes only, and will not trigger any actions on NSP 22. Reception of all future “MCPTEST” commands from NSP 22 results in a “MCPTESTR” message with the MCP status marked as “faulty”. This background test function can be executed at low traffic times, and is implemented in the background-testing task. When a fault is detected, a message is sent to the high-priority task for the purpose of notifying NSP 22.

Maintenance task 52 provides an interface for reporting of software errors from individual MCP Manager tasks. Software errors are classified as “Minor” and “Major”. Minor software errors results in a MCP_STAF message being sent to NSP 22, and error data logging. Error data is logged in a special section of the MCP flash memory. This data includes error notebook information from MCTs, if relevant. Major software errors result in a MCP_STAF message, data logging, and a reset of MCP 28. This interface can be used for reporting of failures such as Memory Exhaustion, Data corruption, etc. Notification of software errors is time critical so this function is provided by the high-priority maintenance task.

A single software image is shared by all the media control tasks. In order to verify that one of the tasks has not corrupted this image, Maintenance Task 58 performs a periodic background checksum verification of this image. If the image is found to be faulty, then this task triggers a restart of the entire MCP. NSP 22 is notified of this event as part of the normal platform restart sequence, and via a MCP_STAF message.

This audit is a low-traffic activity and is performed by the background-testing task. When a fault is detected, a message is sent to the high-priority maintenance task in order to notify NSP 22.

Maintenance Task 58 defines data to store the current MCP fault status. This status is initialized to “No Faults” on startup of MCP 28. In addition, data is also defined to store the current MCP load information. A special region of MCP flash memory is allocated for logging of software errors.

When operating on MCP 28, patching of the MCTs is coordinated to avoid accidental corruption of a MCTs execution environment by another MCT which is applying a patch. Patch coordination is implemented by the low-priority Maintenance Task. When a patch is received by a MCT, it performs all actions in preparation of applying the patch, except the actual patch write to memory. Instead of this step, the MCT invokes the MCP Patch Function by sending a message to the low priority maintenance task. No response is sent to NSP 22. The low priority maintenance task only runs when all the MCTs have reached an “idle” state and are blocked on their message queues. This ensures that the MCTs are in “patch safe” code. When the patch message is received by the low priority maintenance task, it first executes a “task lock” function to prevent the MCTs from executing while the patch is being incorporated. It then updates the MCT code with the patch (contents taken from a shared memory buffer) and updates the corresponding code checksum values. It also notifies the background testing task of the change in code checksum. After the patch has been incorporated, a message is sent to the MCT to trigger a response to NSP 22 and normal scheduling is resumed.

The software images that will be maintained on MCP 28, in non-volatile memory include Boot Software, Current MCP Load Image, and Backup MCP Load Image. Boot software is an enhancement of the default VxWorks BootRom. It contains the minimum operating system functionality that is necessary to initialize MCP hardware, and access the MCP non-volatile memory device. Boot software is always started on MCP reset. It is responsible for selecting the appropriate MCP Load image to start, based on header information within the MCP load files. The Current MCP Load image contains all the MCP software as well as all VxWorks operating system functionality necessary for MCP 28.

Of the three loads described above, only the Current & Backup loads can be field-upgraded. The Boot Software is never field-upgraded. It can be upgraded only by rebooting MCP 28 from floppy disk, and re-initializing the boot area of the MCP non-volatile storage device.

Load management of the MCP software versions is performed on the Integrated Management System (IMS). Software on this platform provides interfaces to ICC 24 and MCP 28 for version query and on-demand loading.

Within MCP 28, the MCP Upgrade Task handles upgrade of MCP software. Upgrade of MCP 28 can be triggered through the following two interfaces: NSP during MCP activation (System Recovery or Configuration) and IMS on demand. Regardless of the interface used, MCP upgrade includes three actions: version checking, downloading of a new image, and reset and activation of the new Image.

MCP Upgrade is triggered by NSP 22 when a MCP is restored into service, either due to System Recovery or MCP Configuration, NSP 22 requests a version check of MCP 28 software using the Command MCPSW. On receiving this command, the MCP Upgrade task initiates a query to the IMS, in order to determine the official current version of available MCP software. If the version on the IMS is the same as the CURRENT MCP software image, then a message MCPSWR is returned to NSP 22 indicating that no upgrade of NSP 22 is required.

If the current MCP software version does not match that on the IMS, then NSP 22 the MSPSWR message is returned indicating the mismatch and the need for upgrade. MCP 28 then requests download of the new version from the IMS. During the download, NSP 22 queries MCP 28 regarding the progress of the download using the MSPSW command. The MCP upgrade task responds with the MSPSWR message that includes a percentage of loading that has been completed.

When the entire load has been downloaded, the upgrade task waits for a final MCPSW query command from NSP 22 and responds with 100% complete in the MCPSWR. MCP 28 is then reset to activate the new load. Following activation of the new load, NSP 22 repeats the version check step, which in this case matches the version on the IMS. If the activation of the new load fails for any reason, then NSP 22 aborts the MCP activation at this point.

MCP Upgrade is triggered by the IMS. The IMS provides an operator interface that can be used to query the current version of MCP software, and to initiate an upgrade of either the Current or Backup MCP load versions. This interface uses the BootP protocol. The MCP upgrade task interfaces with the VxWorks TCP/IP stack to provide this interface. Note that upgrade of MCP 28 from the IMS is only initiated when MCP 28 is out-of-service.

Software tools provide integrated utility software used during development, testing, and debugging. Software tools suitable for this embodiment include Wind River's VxWorks and Tornado Tool Kits. Available utility functions include a graphical debugger allowing users to watch expressions, variables, and register values, and set breakpoints as well as a logic analyzer for real-time software. In addition, the developer is given flexibility to build targeted debugging and trace functions or ‘shells’ within the VxWorks environment. Access to MCP 28 is provided through an external v24 interface allowing for onsite or remote access.

The utilities provided for task level debugging include data display and modification, variable watching, and breakpoints. These utilities are integrated within the VxWorks operating system. Logging and tracing functions are implemented to trap and display message data coming into and leaving MCP 28.

Still other embodiments are written within the scope of the claims.

What is claimed is:

1. A method of call processing, comprising:
passing, over a local area network, control signals from a centralized controller to each of a plurality of decentralized processors,
each of the plurality of decentralized processors, in response to the control signals, executing decentralized call control functions.

2. The method of claim 1, wherein passing, over a local network, control signals comprises loading control data from an external device.

3. The method of claim 2, wherein the control data includes data associated with performing maintenance functions.

4. The method of claim 3, wherein the maintenance functions include centralized monitoring.

5. The method of claim 3, wherein the maintenance functions include a redundancy failover.

6. The method of claim 3, further comprising interfacing the distributed processors by tying to a set of soft switch protocols.

7. The method of claim 1, wherein the controller is a mainframe.

8. The method of claim 1, wherein passing control signals is performed using an Internet protocol.

9. The method of claim 1, further comprising associating at a physical layer addresses of the distributed processors with physical locations.

10. The method of claim 9, further comprising overwriting default address with an internal address.

11. The method of claim 1, wherein each of the distributed processors is associated with at least one access device.

12. The method of claim 11, wherein each of the distributed processors is associated with at least one access device over a wide area network.

13. A call processing system comprising:
a centralized controller to send control signals to a plurality of distributed processors,
a local area network to couple the centralized controller to each of the plurality of distributed processors to perform decentralized call processing.

14. The system of claim 13, wherein the control signals are associated with performing maintenance functions.

15. The system of claim 13, wherein each distributed processor has data physical layer addresses that are location based.

16. The system of claim 13, wherein each distributed processor interface has a soft-switch architecture.

17. The system of claim 13, wherein each distributed processor communicates over a wide area network to access gateway devices.

18. The system of claim 17, wherein the gateway devices include a voice over asynchronous transfer mode gateway.

19. The system of claim 17, wherein the gateway devices include a voice over internet protocol gateway.

20. The system of claim 13, wherein each distributed processor has another processor that serves as a redundant partner.

21. The system of claim 13, wherein each processor has a software task.

22. The system of claim 21, wherein the software task is an independent call-processing entity.

23. The system of claim 13, further comprising a packet manager interfacing with an interconnect controller.

24. The system of claim 23, wherein the packet manager interfaces at least one of a server, a router or a firewall.

25. The system of claim 24, further comprising an interconnect controller providing a bidirectional interface between the controller and the distributed processors, the packet manager and signaling gateway

26. The system of claim 25, wherein the centralized controller sends broadcast messages to control the processors.

27. The system of claim 13, wherein the centralized controller includes a local area network control and monitoring device and a call control device.

28. The system of claim 27, wherein the call control device interfaces with telephony signaling network.

29. The system of claim 28, wherein the telephony signaling network is an SS7 network.

30. The system of claim 13, further comprising a packet manager interfacing with the centralized controller.
